(19) United States
(12) Patent Application Publication
(10) Pub. No.: US 2012/0307144 A1
(43) Pub. Date: Dec. 6, 2012

(54) SIGNAL TRANSMISSION APPARATUS, SIGNAL TRANSMISSION METHOD, SIGNAL RECEPTION APPARATUS, SIGNAL RECEPTION METHOD, AND SIGNAL TRANSMISSION SYSTEM

(76) Inventor: Shigeyuki YAMASHITA, Kanagawa (JP)

(21) Appl. No.: 13/486,650

(22) Filed: Jun. 1, 2012

(30) Foreign Application Priority Data
Jun. 6, 2011 (JP) 2011-126674

(51) Int. Cl. H04N 7/04

(52) U.S. Cl. 348/469; 348/E07.04

(57) ABSTRACT

A signal transmission apparatus includes: a horizontal rectangular area thinning-out control section; a line thinning-out control section that thins out pixel samples for every other line of each of first to t-th sub images, into which the pixel samples are mapped, so as to thereby produce interlaced signals; a word thinning-out control section that thins out the pixel samples, which are thinned out for every other line, for every word, and maps the pixel samples into video data areas of HD-SDIs prescribed in SMPTE 435-2; and a readout control section that outputs the HD-SDIs.

### FIELD

The present disclosure relates to a signal transmission apparatus, a signal transmission method, a signal reception apparatus, a signal reception method, and a signal transmission system which are suitably applied for serial transmission of a video signal in which the number of pixels of one frame is greater than the number of pixels prescribed by the HD-SDI (High-Definition Serial Digital Interface) format.

### BACKGROUND

In the related art, there has been progress in development of a reception system or an imaging system for an ultra-high definition video signal superior to an existing HD (High Definition) video signal as a video signal of which a single frame has 1920 samples×1080 lines. For example, a UHDTV (Ultra High Definition TV) standard, which is a broadcasting system of a next generation having a number of pixels equal to 4 times or 16 times that of the existing HD, is standardized by international associations. The international associations include the ITU (International Telecommunication Union) and the SMPTE (Society of Motion Picture and Television Engineers).

Here, JP-A-2005-328494 discloses a technique for transmitting a 3840×2160/30P, 30/1.001P/4:4:4/12-bit signal, which is a kind of 4 k×2 k signal (4 k×2 k ultra-high resolution signal) at a bit rate equal to or higher than 10 Gbps. Note that, a video signal, which is represented by m samples×n lines, is simply referred to as “m×n”. In addition, the term “3840×2160/30P” represents a “the number of pixels in the horizontal direction”×“the number of lines in the vertical direction”/“the number of frames per second”. Further, “4:4:4” represents the ratio of a “red signal R: green signal G: blue signal B” in the case of the primary color signal transmission method or the ratio of a “luminance signal Y: first color difference signal Cb: second color difference signal Cr” in the case of the color difference signal transmission method.

In the following description, 50P, 59.94P, and 60P representing the frame rates of progressive signals are simply referred to as “50P-60P”, and 47.95P, 48P, 50P, 59.94P, and 60P are simply referred to as “48P-60P”. Further, 100P, 119.88P, and 120P are simply referred to as “100P-120P”, and 95.9P, 96P, 100P, 119.88P, and 120P are simply referred to as “96P-120P”. Furthermore, 50I, 59.94I, and 60I representing the frame rates of the interlaced signals are simply referred to as “50I-60I”, and 47.95I, 48I, 50I, 59.94I, and 60I are simply referred to as “48I-60I”. In addition, sometimes, a 3840×2160/100P-120P/4:4:4, 4:2:2, 4:2:0/10-bit, 12-bit signal is simply referred to as “3840×2160/100P-120P signal”. In addition, pixel samples, of which the number is n, are simply referred to as “n pixel samples”.

### SUMMARY

In the recent SMPTE or ITU, a video signal standard or an interface standard of 3840×2160 or 7680×4320 of which a frame rate is 23.98P-60P is standardized. Further, when a mode D (refer to FIG. 6 to be described later) is used for transmission of video data, a 3840×2160/23.98P-30P video signal can be transmitted by a 10G-SDI of one channel. However, no discussion or standardization has been made in regard to a compatible interface for transmission of a video signal of which the frame rate is equal to 120P or greater than 120P. Further, in a video signal standard compatible with 1920×1080 or 2048×1080, the frame rate is prescribed only up to 60P. For this reason, even when using the technique disclosed in JP-A-2005-328494, it is difficult to transmit high-resolution pixel samples through an existing interface.

Further, in the SMPTE, the video signal standard for up to 4096×2160/23.98P-60P is prescribed or standardized, but no argument or no standardization is made in regard to an interface provided in a signal transmission apparatus and a signal reception apparatus. Hence, in the case of the 4096×2160/23.98P-30P video signal, the number of pixel samples stored in the video data areas increases, and thus, in the line structure of the mode D, it is difficult to multiplex the pixel samples and transmit them.

Furthermore, in the case where the video signal is 4096×2160, the frame rate is defined in the range of 23.98P, 24P, 25P, 29.97P, 30P, 47.95P, 48P, 50P, 59.94P, and 60P. However, in the future, it should be considered to transmit the video signal with a frame rate of 90P or 90P or more as a signal of which the frame rate is three times the currently used frame rate (for example 30P). For this reason, it is necessary to develop a specification for transmitting video signals with various frame rates through an existing transmission interface.

Thus, it is desirable to serially transmit the video signal, in which the number of pixels of one frame is greater than the number of pixels prescribed by the HD-SDI format and which has a high frame rate, through an HD-SDI interface or a serial interface of 10 Gbps.

According to an embodiment of the present disclosure, a signal defined by a m×n/a-b/r:g:b/10-bit, 12-bit signal is transmitted (m×n represents m samples and n lines in which m and n are positive integers, a and b are frame rates of progressive signals, and r, g, and b are signal ratios in a prescribed signal transmission method) in which the number of pixels of one frame is greater than the number of pixels prescribed by an HD-SDI format.

Here, the following processing is performed in a case of mapping the pixel samples, which are thinned out from the successive first and second class images, into video data areas of first to t-th sub images (t is an integer equal to or greater than 8) which are defined by a m′×n′/a′−b′/r′:g′:b′/10-bit, 12-bit signal (m′×n′ represents m′ samples and n′ lines in which m′ and n′ are positive integers, a′ and b′ are frame rates of progressive signals, and r′, g′, and b′ are signal ratios in a prescribed signal transmission method).

First, first to t-th horizontal rectangular areas, which are obtained by dividing each of successive first and second class images into t pieces in units of p lines (p is an integer equal to or greater than 1) in a vertical direction, are calculated.

Next, pixel samples, which are read out by dividing a single line into m/m′ pieces for each horizontal direction of the first and second class images, are respectively mapped into the video data areas of the first to t-th sub images for each of the first to t-th horizontal rectangular areas. At this time, the mapping is performed alternately, by p lines at a time, up to a p×m/m′ line in the vertical direction of each line in the video data areas of the first to t-th sub images. Then, the mapping processing is repeated in order from the first class image to the second class image.

Furthermore, the pixel samples, which are read out from the first class image, are mapped into each line of the video data areas of the first to t-th sub images in units of p×m/m′ lines. Next, the pixel samples, which are read out from the second class image, is mapped into a line vertically subsequent to the line, into which the pixel samples are mapped, in units of p×m/m′ lines.

Then, the pixel samples are thinned out for every other line of each of the first to t-th sub images, into which the pixel samples are mapped, so as to thereby produce interlaced signals, and the pixel samples, which are thinned out for every other line, are thinned out for every word, and are mapped into video data areas of HD-SDIs prescribed in SMPTE 435-2, thereby outputting the HD-SDIs.

Further, according to another embodiment of the present disclosure, HD-SDIs are stored in a storage section, and word multiplexing is performed on the pixel samples, which are extracted from the video data areas of the HD-SDIs read out from the storage section, for every line.

Next, the pixel samples, on which the word multiplexing is performed, are multiplexed into first to t-th sub images, which are defined by a m′×n′/a′−b′/r′:g′:b′/10-bit, 12-bit signal, for every line so as to thereby produce progressive signals (m′×n′ represents m′ samples and n′ lines in which m′ and n′ are positive integers, a′ and b′ are frame rates of progressive signals, and r′, g′, and b′ are signal ratios in a prescribed signal transmission method).

Subsequently, pixel samples, which are read out from video data areas of first to t-th sub images, are multiplexed into successive first and second class images in which the number of pixels of one frame is greater than the number of pixels prescribed by an HD-SDI format and which are defined by a m×n/a-b/r:g:b/10-bit, 12-bit signal (m×n represents m samples and n lines in which m and n are positive integers, a and b are frame rates of progressive signals, and r, g, and b are signal ratios in a prescribed signal transmission method).

In this case, first to t-th horizontal rectangular areas, which are obtained by dividing each of the first and second class images into t pieces in units of p lines (p is an integer equal to or greater than 1) in a vertical direction, are calculated.

Next, pixel samples, which are read out up to a p×m/m′ line in a vertical direction in the video data areas of the first to t-th sub images, are alternately multiplexed into respective lines, each of which is divided into m/m′ pieces, in the first to t-th horizontal rectangular areas up to a p line in the first class image.

The multiplexing processing is repeated in order from the first class image to the second class image. In this case, the pixel samples, which are read out from each line of the video data areas of the first to t-th sub images in units of p×m/m′ lines, is multiplexed into the first class image.

Then, the pixel samples, which are read out in units of p×m/m′ lines from a line vertically subsequent to the line at which the pixel samples are read out from the video data areas of the first to t-th sub images, is multiplexed into the second class image.

Further, according to still another embodiment of the present disclosure, there is provided a signal transmission system that transmits the video signals and receives the video signals.

According to yet another embodiment of the present disclosure, the horizontal rectangular area thinning-out, the line thinning-out, and the word thinning-out are performed on an input video signal in units of successive two frames (or two or more frames), and the signal, in which the pixel samples are multiplexed into the video data areas of the HD-SDIs, is transmitted. On the other hand, in the received signal, the pixel samples are extracted from the video data areas of the HD-SDIs, and the word multiplexing, the line multiplexing, and the horizontal rectangular area multiplexing are performed, thereby reproducing the video signal.

According to the embodiments of the present disclosure, various kinds of thinning-out processing are performed when the 3840×2160/100P-120P/4:4:4, 4:2:2, 4:2:0/10-bit, 12-bit signal is transmitted. Then, the pixel samples are mapped into the video data areas of the HD-SDIs in the mode D of the 10 Gbps serial interface. Further, the pixel samples are extracted from the video data areas of the HD-SDIs, and various kinds of the multiplexing processing is performed, thereby reproducing the 3840×2160/100P-120P/4:4:4, 4:2:2, 4:2:0/10-bit, 12-bit signal. Hence, it is possible to transmit and receive the video signal in which the number of pixels of one frame is greater than the number of pixels prescribed by the HD-SDI format and which has a higher frame rate of 100P-120P or more. Further, since it is possible to use a transmission standard used in the related art without providing a new transmission standard, there is an advantage to improve convenience in use.

### BRIEF DESCRIPTION OF THE DRAWINGS

FIG. 1 is a diagram illustrating a configuration of an entire camera transmission system for a television broadcast station according to a first embodiment of the present disclosure;

FIG. 2 is a block diagram illustrating an example of an internal configuration of a signal transmission apparatus in a circuit configuration of the broadcast camera according to the first embodiment of the present disclosure;

FIG. 3 is a block diagram illustrating an example of an internal configuration of a mapping section according to the first embodiment of the present disclosure;

FIGS. 4A to 4C are explanatory diagrams illustrating an example of a sample structure of the UHDTV standard for 3840×2160;

FIG. 5 is an explanatory diagram illustrating an example of a data structure for a single line of serial digital data of 10.692 Gbps in the case of 24P;

FIG. 6 is an explanatory diagram illustrating an example of the mode D;

FIG. 7 is an explanatory diagram illustrating processing in which the mapping section according to the first embodiment of the present disclosure maps pixel samples;

FIG. 8 is an explanatory diagram illustrating an example of processing in which a horizontal rectangular area thinning-out control section according to the first embodiment of the present disclosure thins out the pixel samples in horizontal rectangular areas in units of 270 lines in the vertical direction from first and second class images, and maps them into first to eighth sub images;

FIG. 9 is an explanatory diagram illustrating an example in which the first to eighth sub images according to the first embodiment of the present disclosure are subjected to the line thinning-out, are subsequently subjected to the word thinning-out, and are divided into a link A or a link B in conformity with the prescription of the SMPTE 372M;

FIGS. 10A and 10B are explanatory diagrams illustrating examples of data structures of the links A and B based on the SMPTE 372;

FIGS. 11A and 11B are explanatory diagrams illustrating examples of data multiplexing processing which is performed by the multiplexing section according to the first embodiment of the present disclosure;

FIG. 12 is a block diagram illustrating an example of an internal configuration of a signal reception apparatus in the circuit configuration of a CCU according to the first embodiment of the present disclosure;

FIG. 13 is a block diagram illustrating an example of an internal configuration of a reproduction section according to the first embodiment of the present disclosure;

FIG. 14 is an explanatory diagram illustrating processing in which a mapping section according to a second embodiment of the present disclosure maps the pixel samples included in an UHDTV2 class image into UHDTV1 class images.

FIG. 15 is a block diagram illustrating an example of an internal configuration of the mapping section according to the second embodiment of the present disclosure;

FIG. 16 is a block diagram illustrating an example of an internal configuration of a reproduction section according to the second embodiment of the present disclosure;

FIG. 17 is an explanatory diagram illustrating processing in which a mapping section according to a third embodiment of the present disclosure maps the pixel samples included in the UHDTV1 class image into first to 4N-th sub images;

FIG. 18 is an explanatory diagram illustrating processing in which a mapping section according to a fourth embodiment of the present disclosure maps the pixel samples included in the UHDTV2 class image, of which the frame rate is N times 50P-60P, into the UHDTV1 class images of which the frame rate is N times 50P-60P;

FIG. 19 is an explanatory diagram illustrating an example of the mode B;

FIG. 20 is an explanatory diagram illustrating processing in which a mapping section according to a fifth embodiment of the present disclosure maps the pixel samples included in a 4096×2160 class images, of which the frame rate is 96P-120P, into first to eighth sub images; and

FIG. 21 is an explanatory diagram illustrating an example in which the mapping section according to the fifth embodiment of the present disclosure performs the line thinning-out and the word thinning-out on the first to eighth sub images, and maps them in the mode B.

### DETAILED DESCRIPTION

Hereinafter, preferred embodiments (hereinafter referred to as embodiments) of the present disclosure will be described. Note that, the description will be given in the following order: 1. First Embodiment (pixel sample mapping control: an example of 3840×2160/100P-120P/4:4:4, 4:2:2, 4:2:0/10-bit, 12-bit); 2. Second Embodiment (pixel sample mapping control: an example of the UHDTV2 7680×4320/100P-120P/4:4:4, 4:2:2, 4:2:0/10-bit, 12-bit); 3. Third Embodiment (pixel sample mapping control: an example of 3840×2160/(50P-60P)×N/4:4:4, 4:2:2, 4:2:0/10-bit, 12-bit); 4. Fourth Embodiment (pixel sample mapping control: an example of the UHDTV2, 7680×4320/(50P-60P)×N/4:4:4, 4:2:2, 4:2:0/10-bit, 12-bit); 5. Fifth Embodiment (pixel sample mapping control: an example of 4096×2160/96P-120P/4:4:4, 4:2:2/10-bit, 12-bit); and 6. Modified Example.

### First Embodiment

### Example of 3840×2160/100P-120P/4:4:4, 4:2:2, 4:2:0/10-Bit, 12-Bit

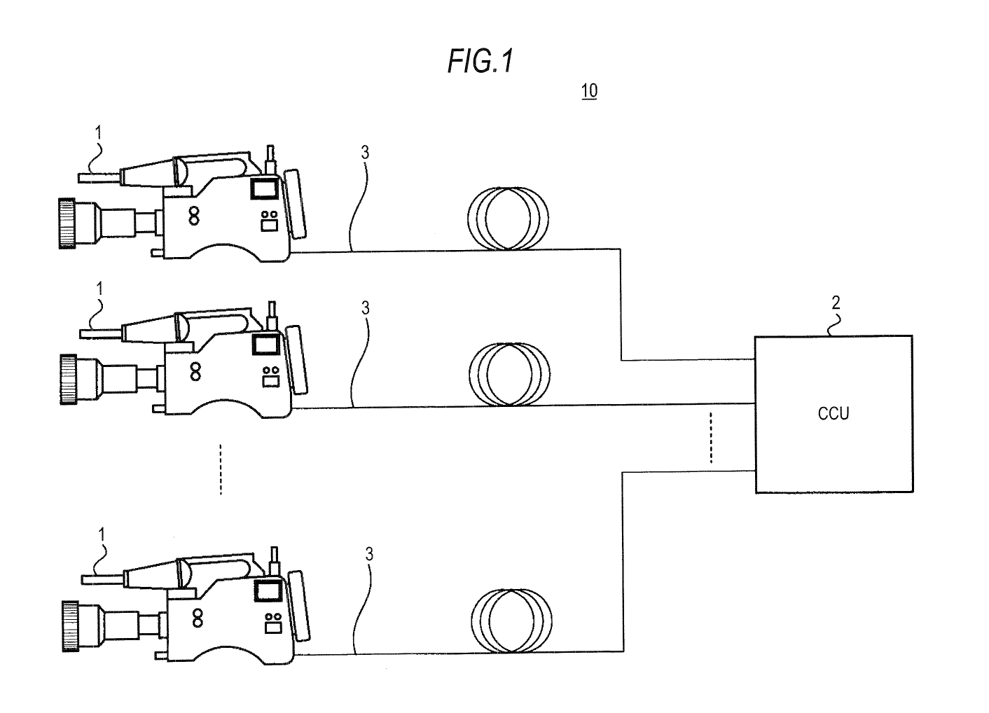

Hereinafter, a first embodiment of the present disclosure will be described with reference to FIGS. 1 to 13.

Here, a description will be given of a method of thinning out pixel samples of a 3840×2160/100P-120P/4:4:4, 4:2:2, 4:2:0/10-bit, 12-bit signal in a transmission system according to the first embodiment. Note that, the signal is a signal of which the frame rate is twice that of the 3840×2160/50P-60P/4:4:4, 4:2:2, 4:2:0/10-bit, 12-bit signal prescribed by SMPTE S2036-1. In addition, even when the color gamut (Colorimetry) is different, the digital signal form such as inhibition codes is the same.

FIG. 1 is a diagram illustrating a configuration of an entire signal transmission system 10 for a television broadcast station according to the present embodiment. The signal transmission system 10 includes a plurality of broadcast cameras 1 having the same configurations and a camera control unit (CCU) 2. The broadcast cameras 1 are connected to the CCU 2 by respective optical fiber cables 3. Each of the broadcast cameras 1 is used as a signal transmission apparatus to which a signal transmission method of transmitting a serial digital signal (video signal) is applied, and the CCU 2 is used as a signal reception apparatus to which a signal reception method of receiving the serial digital signal is applied. In addition, the signal transmission system 10 which includes the combination of the broadcast cameras 1 and the CCU 2 is used as a signal transmission system for transmitting and receiving a serial digital signal. Further, the processing performed by such apparatuses can be implemented not only by executing the processing in conjunction with hardware but also by executing a program.

The broadcast camera 1 produces an ultra-high resolution signal of 4 k×2 k (3840×2160/100P-120P/4:4:4, 4:2:2, 4:2:0/10-bit, 12-bit signal) of the UHDTV1, and transmits the signal to the CCU 2.

The CCU 2 controls the broadcast cameras 1, receives video signals from the broadcast cameras 1 and transmits a video signal (return video) for causing a monitor of each broadcast camera 1 to display images during image capturing by the other broadcast cameras 1. The CCU 2 functions as a signal reception apparatus for receiving video signals from the respective broadcast cameras 1.

### [Next-Generation 2 k, 4 k, and 8 k Video Signals]

Here, next-generation 2 k, 4 k, and 8 k video signals will be described.

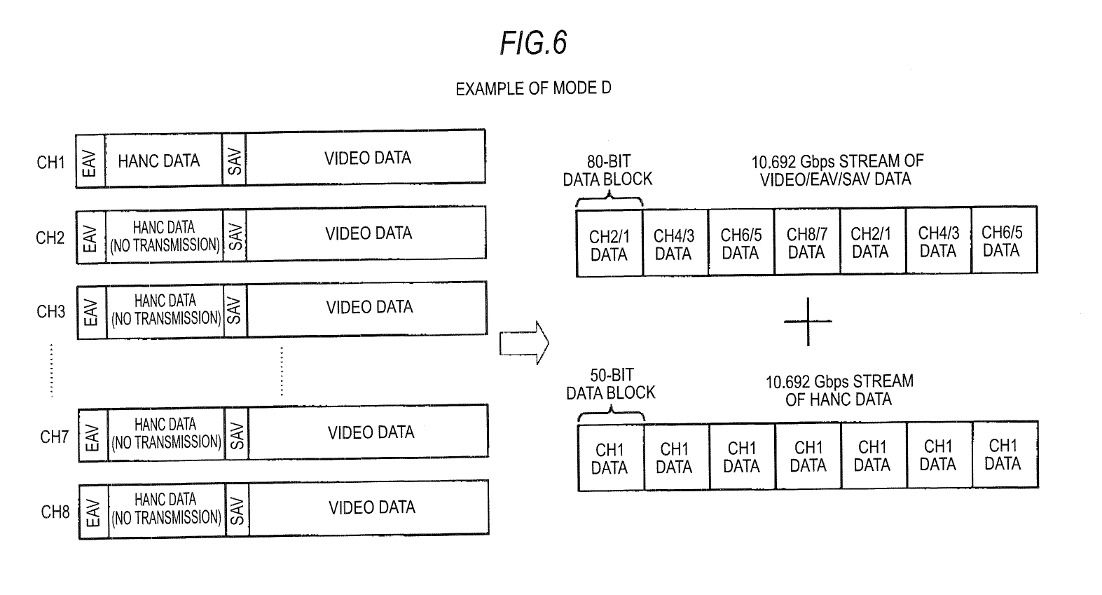

As an interface for transmitting and receiving video signals with various frame rates, a transmission standard known as the mode D (refer to FIG. 6 to be described later) is added to the SMPTE 435-2, and standardization is completed as SMPTE 435-2-2009. The SMPTE 435-2 describes processing of multiplexing data on a plurality of HD-SDI channels as 10-bit parallel streams prescribed by the SMPTE 292 in a serial interface of 10.692 Gbps. Normally, a field of each HD-SDI includes, in order of precedence, EAV, horizontal auxiliary data space (also called HANC data, a horizontal blanking period), SAV, and video data. In addition, according to the UHDTV standard, the SMPTE proposed, as SMPTE 2036-3, a method of transmitting a 3840×2160/60P signal through 10 Gbps interfaces of two channels and transmitting a 7680/4320/60P signal through 10 Gbps interfaces of eight channels.

The video standard proposed by the ITU or the SMPTE relates to a video signal having the number of samples and the number of lines equal to twice or four times those of 1920×1080, that is, having 3840×2160 or 7680×4320. That one of the video signals which is standardized by the ITU is called LSDI (Large Screen Digital Imagery), and that one which is proposed by the SMPTE is called UHDTV. Regarding the UHDTV, signals of the following Table 1 are prescribed.

TABLE 1

| | | NUMBER OF | | |
|---|---|---|---|---|
| | | R′G′B′ SAM- | | |
| | | PLES AND | NUMBER OF | |
| SYSTEM | | LUMINANCE | EFFECTIVE | FRAME |
| CATE- | SYSTEM | PER EFFEC- | LINES PER | RATE |
| GORY | NAME | TIVE LINES | FRAME | (Hz) |
| UHDTV1 | 3840×2160/ | 3840 | 2160 | 24/1.001 |
| | 23.98/P | | | |
| | 3840×2160/ | 3840 | 2160 | 24 |
| | 24/P | | | |
| | 3840×2160/ | 3840 | 2160 | 25 |
| | 25/P | | | |
| | 3840×2160/ | 3840 | 2160 | 30/1.001 |
| | 29.97/P | | | |
| | 3840×2160/ | 3840 | 2160 | 30 |
| | 30/P | | | |
| | 3840×2160/ | 3840 | 2160 | 50 |
| | 50/P | | | |
| | 3840×2160/ | 3840 | 2160 | 60/1.001 |
| | 59.94/P | | | |
| | 3840×2160/ | 3840 | 2160 | 60 |
| | 60/P | | | |
| UHDTV2 | 7680×4320/ | 7680 | 4320 | 24/1.001 |
| | 23.98/P | | | |
| | 7680×4320/ | 7680 | 4320 | 24 |
| | 24/P | | | |
| | 7680×4320/ | 7680 | 4320 | 25 |
| | 25/P | | | |
| | 7680×4320/ | 7680 | 4320 | 30/1.001 |
| | 29.97/P | | | |
| | 7680×4320/ | 7680 | 4320 | 30 |
| | 30/P | | | |
| | 7680×4320/ | 7680 | 4320 | 50 |
| | 50/P | | | |
| | 7680×4320/ | 7680 | 4320 | 60/1.001 |
| | 59.94/P | | | |
| | 7680×4320/ | 7680 | 4320 | 60 |
| | 60/P | | | |

Further, in the following Tables 2 and 3, as standards employed in digital cameras for film industry, signal standards of 2048×1080 and 4096×2160 are standardized as SMPTE 2048-1 and 2048-2.

TABLE 2

| SYSTEM NUMBER | SYSTEM NAME | FRAME RATE (Hz) |
|---|---|---|
| 1 | 2048×1080/60/P | 60 |
| 2 | 2048×1080/59.94/P | 60/1.001 |
| 3 | 2048×1080/50/P | 50 |
| 4 | 2048×1080/48/P | 48 |
| 5 | 2048×1080/47.95/P | 48/1.001 |
| 6 | 2048×1080/30/P | 30 |
| 7 | 2048×1080/29.97/P | 30/1.001 |
| 8 | 2048×1080/25/P | 25 |
| 9 | 2048×1080/24/P | 24 |
| 10 | 2048×1080/23.98/P | 24/1.001 |

TABLE 3

| SYSTEM NUMBER | SYSTEM NAME | FRAME RATE (Hz) |
|---|---|---|
| 1 | 4096×2160/60/P | 60 |
| 2 | 4096×2160/59.94/P | 60/1.001 |
| 3 | 4096×2160/50/P | 50 |
| 4 | 4096×2160/48/P | 48 |
| 5 | 4096×2160/47.95/P | 48/1.001 |
| 6 | 4096×2160/30/P | 30 |
| 7 | 4096×2160/29.97/P | 30/1.001 |
| 8 | 4096×2160/25/P | 25 |
| 9 | 4096×2160/24/P | 24 |
| 10 | 4096×2160/23.98/P | 24/1.001 |

### [DWDM/CWDM Wavelength Multiplexing Transmission Technique]

Next, a DWDM/CWDM wavelength multiplexing transmission technique will be described.

A method of multiplexing and transmitting light of a plurality of wavelengths through a single optical fiber is called WDM (Wavelength Division Multiplexing). The WDM is roughly divided into the following three methods depending upon the wavelength distance.

### (1) Two-Wavelength Multiplexing Method

The two-wavelength multiplexing method is a method of multiplexing signals with different wavelengths of for example 1.3 μm and 1.55 μm by an amount of about two or three waves and transmitting the signals through a single optical fiber.

### (2) DWDM (Dense Wavelength Division Multiplexing) Method

The DWDM is a method of multiplexing and transmitting light with a high density at light frequencies of 25 GHz, 50 GHz, 100 GHz, 200 GHz, and the like particularly in the 1.55 μm band. The wavelength intervals therebetween are approximately 0.2 nm, 0.4 nm, 0.8 nm, and the like. Standardization of the center frequency and the like has been carried out by the ITU-T (International Telecommunication Union Telecommunication standardization sector). Since the wavelength interval of the DWDM is as narrow as 100 GHz, the number of waves to be multiplexed can be made as great as several tens to hundreds, and it is possible to perform ultra-high capacity communication. However, it is necessary for the oscillation wavelength width to be sufficiently narrower than the wavelength interval of 100 GHz, and it is necessary for the temperature of the semiconductor laser to be controlled so that the center frequencies may comply with the ITU-T standard. Hence, the device is expensive, and high power consumption is necessary for the system.

### (3) CWDM (Coarse Wavelength Division Multiplexing) Method

The CWDM is a wavelength multiplexing technique in which the wavelength interval is set to 10 to 20 nm which is greater than that in the DWDM by one or more digits. Since the wavelength interval is comparatively great, there is no necessity to set the oscillation wavelength band width of the semiconductor layer as narrow as that in the DWDM, and there is no necessity to control the temperature of the semiconductor laser either. Therefore, it is possible to form the system at a low cost and with low power consumption. This technique is effectively applicable to a system for which a large capacity as DWDM is not necessary. As regards the center wavelengths, recently, in a 4-channel configuration, for example, 1.511 μm, 1.531 μm, 1.551 μm, and 1.571 μm are generally used. In addition, in an 8-channel configuration, for example, 1.471 μm, 1.491 μm, 1.511 μm, 1.531 μm, 1.551 μm, 1.571 μm, 1.591 μm, and 1.611 μm are generally used.

The frame rate of the 3840×2160/100P-120P/4:4:4, 4:2:2, 4:2:0/10-bit, 12-bit signal used in the present embodiment is twice that of a signal prescribed by the SMPTE S2036-1. The signal prescribed by the SMPTE S2036-1 is a 3840×2160/50P-60P/4:4:4, 4:2:2, 4:2:0/10-bit, 12-bit signal. In addition, the digital signal form such as inhibition codes is the same as that of an existing signal prescribed by the S2036-1.

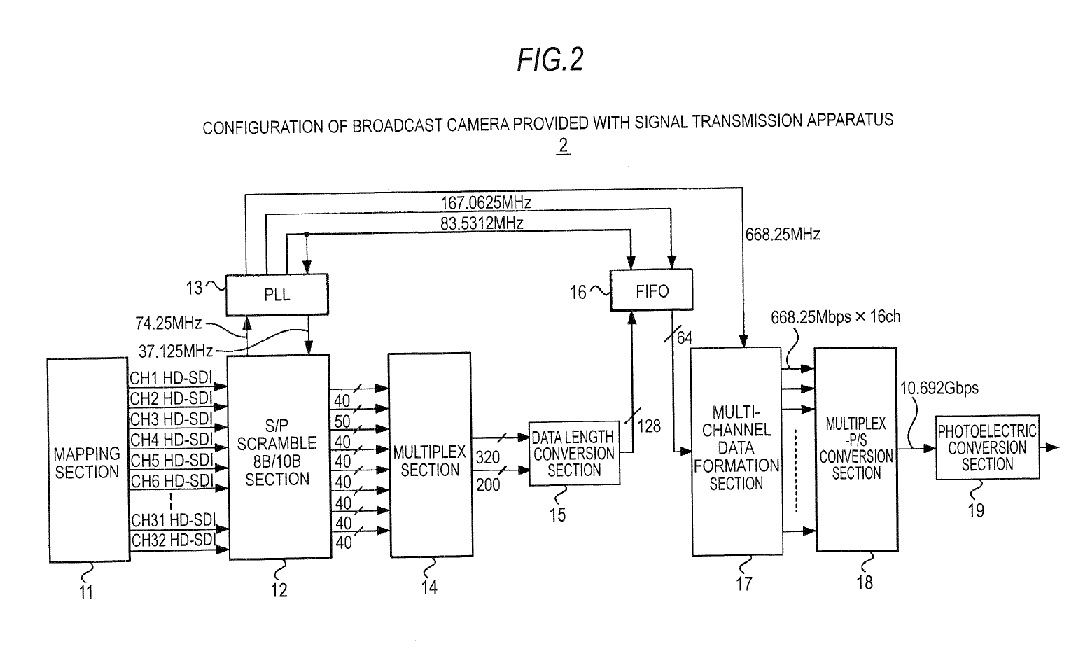

FIG. 2 is a block diagram illustrating a signal transmission apparatus according to the present embodiment in a circuit configuration of the broadcast camera 1. A 3840×2160/100P-120P/4:4:4, 4:2:2, 4:2:0/10-bit, 12-bit signal, which is produced by an imaging section and a video signal processing section (not shown) in the broadcast camera 1, is sent to a mapping section 11.

The 3840×2160/100P-120P/4:4:4, 4:2:2, 4:2:0/10-bit, 12-bit signal corresponds to one frame of the UHDTV1 class image. In addition, the signal is a signal of 30 or 36 bits wide in which a G data sequence, a B data sequence and an R data sequence all having a word length of 10 bits or 12 bits are disposed in parallel and in synchronization with each other. The one frame period is 1/100, 1/119.88 or 1/120 second, and the one frame period includes a period of 2160 effective lines. For this reason, the pixel number of one frame of the video signal is greater than the pixel number prescribed by the HD-SDI format. Then, an audio signal is input in synchronization with the video signal.

The number of samples of the active lines of the UHDTV1 or the UHDTV2 Prescribed by S2036-1 is 3840, the number of lines thereof is 2160, and video data pieces of G, B and R are disposed in the active lines of the G data sequence, B data sequence and R data sequence, respectively.

The mapping section 11 maps the 3840×2160/100P-120P/4:4:4, 4:2:2, 4:2:0/10-bit, 12-bit signal into video data areas of 32 channels prescribed by the HD-SDI format.

### [Example of Internal Configuration and Operation of Mapping Section]

Here, an example of an internal configuration and an operation of the mapping section 11 will be described.

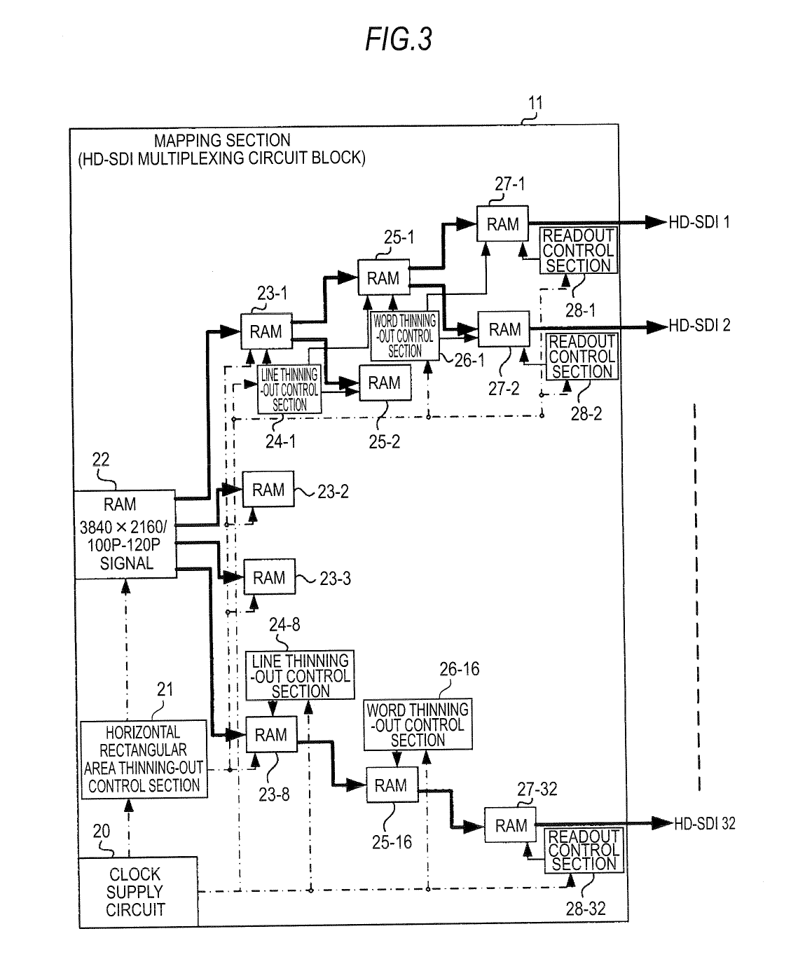

FIG. 3 shows an example of the internal configuration of the mapping section 11.

The mapping section 11 includes a clock supply circuit 20 which supplies a clock to the respective sections thereof, and a RAM 22 for storing a 3840×2160/100P-120P video signal. Further, the mapping section 11 includes a horizontal rectangular area thinning-out control section 21 which controls horizontal rectangular area thinning-out (interleave) for reading out pixel samples in units of p lines in the vertical direction in the first and second UHDTV1 class images of successive two frame units from the RAM 22. In this example, it is assumed that p is equal to 270, and it means “270 lines”. Hereinafter, under this assumption, thinning-out processing and multiplexing processing will be described.

Further, the mapping section 11 includes RAMs 23-1 to 23-8 which store the pixel samples, which are included in the 270 lines thinned out in the vertical direction from the UHDTV1 class images, in video data areas of first to eighth sub images. The 270 lines, which are thinned out in the vertical direction by the horizontal rectangular area thinning-out control section 21, is equal to a value obtained by dividing “2160”, which is the number of effective lines in the vertical direction in each UHDTV1 class image, by “8” which is the number of the first to eighth sub images into which the pixel samples are mapped. In the following description, the “horizontal rectangular areas” are defined as rectangular areas which are obtained by dividing the UHDTV1 class image into t pieces (t is an integer equal to or greater than 8) in units of p lines and each of which has long sides in the horizontal direction and has short sides in the vertical direction.

Further, the mapping section 11 includes line thinning-out control sections 24-1 to 24-8 which control the line thinning-out of the first to eighth sub images stored in the RAMs 23-1 to 23-8. Further, the mapping section 11 includes RAMs 25-1 to 25-16 into which the lines thinned out by the line thinning-out control sections 24-1 to 24-8 are written.

Further, the mapping section 11 includes word thinning-out control sections 26-1 to 26-16 for controlling word thinning-out of data read out from the RAMs 25-1 to 25-16. The mapping section 11 further includes RAMs 27-1 to 27-32 into which words thinned out by the word thinning control sections 26-1 to 26-16 are written.

Further, the mapping section 11 includes readout control sections 28-1 to 28-32 for outputting words which are read out from the RAMs 27-1 to 27-32 as HD-SDIs of 32 channels.

Note that, FIG. 3 shows processing blocks for producing the HD-SDIs 1 and 2, but also shows blocks for producing the HD-SDIs 3 to 32 by using a similar configuration example, and thus illustration and detailed description thereof will be omitted.

Next, an operation example of the mapping section 11 will be described.

First, the clock supply circuit 20 supplies a clock to the horizontal rectangular area thinning-out control section 21, the line thinning-out control sections 24-1 to 24-8, the word thinning-out control sections 26-1 to 26-16, and the readout control sections 28-1 to 28-32. This clock is used for reading out or writing of pixel samples, and the respective sections are synchronized with each other by the clock.

The RAM 22 stores a video signal defined by the UHDTV1 class image of which the number of pixels of one frame input from an image sensor not shown is maximum 3840×2160 and is greater than the number of pixels prescribed by the HD-SDI format. The UHDTV1 class image includes successive first and second class images. The class image of UHDTV1 represents a 3840×2160/100P-120P/4:4:4, 4:2:2, 4:2:0/10-bit, 12-bit video signal. Meanwhile, a 1920×1080/50P-60P/4:4:4, 4:2:2, 4:2:0/10-bit, 12-bit signal is called a “sub image”. In this example, the pixel samples, which are thinned out for each horizontal rectangular area (that is, for each 270 lines in the vertical direction) from the class image of the UHDTV1 input in units of successive two frames, are mapped into video data areas of first to t-th sub images. Here, t is an integer equal to or greater than 8, and in this example, a description will be given of processing of mapping the pixel samples into video data areas of first to eighth sub images.

The horizontal rectangular area thinning-out control section 21 thins out the pixel samples for each 270 lines in the vertical direction in units of successive two frames from the class image of the UHDTV1. Then, the pixel samples are mapped into the video data areas of the first to eighth sub images corresponding to 1920×1080/50P-60P prescribed by the SMPTE 274. An example of the detailed processing for the mapping will be described later.

Next, the line thinning-out control sections 24-1 to 24-8 convert progressive signals into interlaced signals. Specifically, the line thinning-out control sections 24-1 to 24-8 read out the pixel samples mapped into the video data areas of the first to eighth sub images from the RAMs 23-1 to 23-8. At this time, the line thinning-out control sections 24-1 to 24-8 convert one sub image into 1920×1080/50I-60I/4:4:4, 4:2:2, 4:2:0/10-bit, 12-bit signals of two channels. Then, the 1920×1080/50I-60I signals, which are produced as interlaced signals by thinning out every other line from the video data areas of the first to eighth sub images, are written into the RAMs 23-1 to 23-8.

Subsequently, the word thinning-out control sections 26-1 to 26-16 thin out the pixel samples, which are thinned out for each line, for each word, and map the pixel samples into the video data areas of the HD-SDIs prescribed by the SMPTE 435-1. At this time, the word thinning-out control sections 26-1 to 26-16 multiplex the pixel samples into the video data areas of the 10.692 Gbps stream which is prescribed in the SMPTE 435-1 and is determined by the mode D of four channels corresponding to each of the first to eighth sub images. That is, the word thinning-out control sections 26-1 to 26-16 convert the 1920×1080/50I-60I/4:4:4, 4:2:2, 4:2:0/10-bit, 12-bit signals into 32 HD-SDIs. Then, the pixel samples are mapped into the video data areas of four HD-SDIs prescribed in the SMPTE 435-1 for each of the first to eighth sub images.

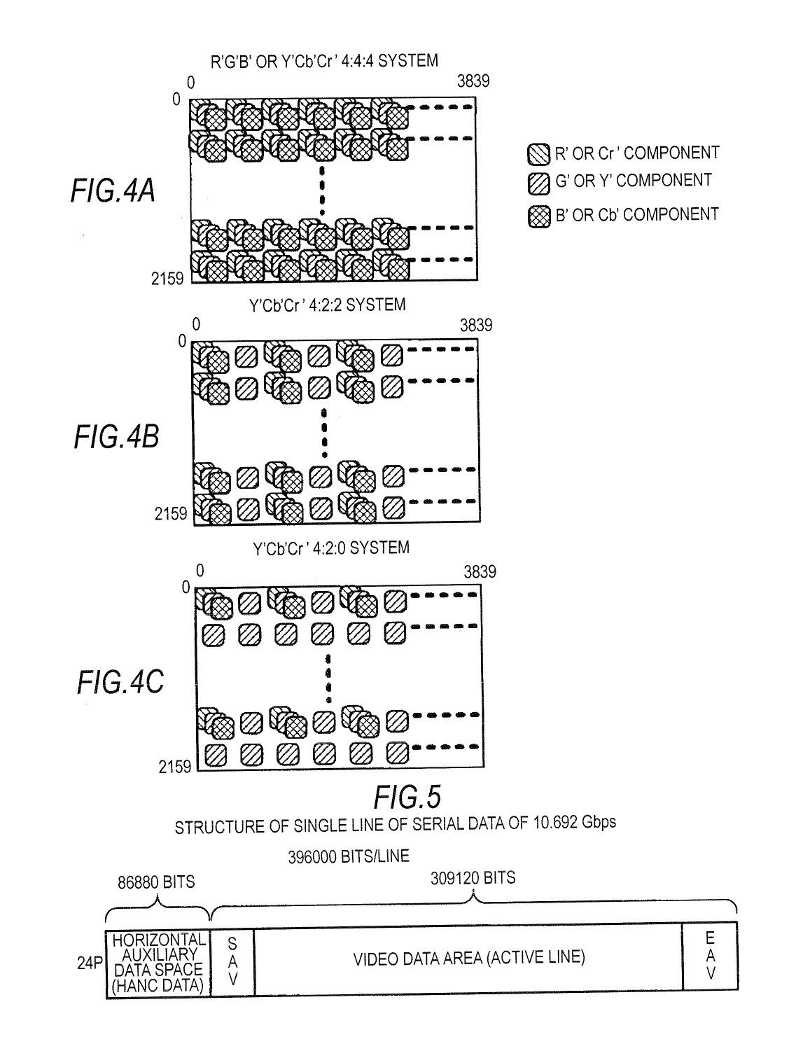

Specifically, the word thinning-out control sections 26-1 to 26-16 readout pixel samples from the RAMs 23-1 to 23-8 by thinning out the pixel samples for each word in a method same as that of FIGS. 4A to 4C, 6, 7, 8 and 9 of the SMPTE 372. Then, the word thinning-out control sections 26-1 to 26-16 convert the read out pixel samples individually into 1920×1080/50I-60I signals of two channels, and store the signals in the RAMs 27-1 to 27-32.

Thereafter, the readout control sections 28-1 to 28-32 output the transmission streams of the 32 HD-SDIs which are read out from the RAMs 27-1 to 27-32.

Specifically, the readout control section 28-1 to 28-32 readout pixel samples from the RAMs 27-1 to 27-32 in response to a reference clock supplied thereto from the clock supply circuit 20. Then, the HD-SDIs 1 to 32 of 32 channels formed of 16 Pairs of two links A and B are output to an S/P scramble 8B/10B section 12 at the succeeding stage.

Note that, in this example, in order to perform horizontal rectangular area thinning-out, line thinning-out, and word thinning-out, three kinds of memories, that is, the RAMs 23-1 to 23-8, RAMs 25-1 to 25-16, and RAMs 27-1 to 27-32, are used, thereby performing three-stage thinning-out processing. However, data, which is obtained by performing the horizontal rectangular area thinning-out, the line thinning-out, and the word thinning-out in a single memory, may be output as HD-SDIs of 32 channels.

### [Example of Sample Structure of UHDTV Signal Standard]

Here, an example of a sample structure of the UHDTV signal standard will be described with reference to FIGS. 4A to 4C.

FIGS. 4A to 4C are explanatory diagrams illustrating an example of a sample structure of the UHDTV standard for 3840×2160. As a frame used in the description with reference to FIGS. 4A and 4B, one frame is formed by 3840×2160.

According to the signal standard for 3840×2160, three sample structures described below are available. Note that, in the SMPTE standard, a signal having a dash “′” applied thereto like R′, G′ or B′ represents a signal to which gamma correction is applied.

FIG. 4A shows an example of the sample structure of the R′G′B′, Y′Cb′Cr′ 4:4:4 system. In this system, RGB or YCbCr components are included in all samples.

FIG. 4B shows an example of the sample structure of the Y′Cb′Cr′ 4:2:2 system. In this system, YCbCr components are included in even-numbered samples, and a component of Y is included in odd-numbered samples.

FIG. 4C shows an example of the sample structure of the Y′Cb′Cr′ 4:2:0 system. In this system, YCbCr components are included in even-numbered samples, a component of Y is included in odd-numbered samples, and CbCr components are thinned out in odd-numbered lines.

### [Configuration Example of Serial Data of 10.692 Gbps]

Next, a configuration example of serial data of 10.692 Gbps prescribed by the HD-SDI format for a single line will be described with reference to FIG. 5.

FIG. 5 shows an example of the data structure for a single line of the serial digital data of 10.692 Gbps in the case where the frame rate thereof is 24P.

In the drawing, serial digital data including the line number LN and error detection codes CRC are indicated as SAV, an active line, and EAV, and serial digital data including an area for additional data are indicated as horizontal auxiliary data space. In the horizontal auxiliary data space, an audio signal is mapped. Thus, complementary data are added to the audio signal so as to form the horizontal auxiliary data space, whereby it is possible to establish synchronization with the input HD-SDIs.

### [Description of Mode D]

Next, an example, in which data included in the HD-SDIs of a plurality of channels is multiplexed, will be described with reference to FIG. 6. A method of multiplexing data is defined by the mode D in the SMPTE 435-2.

FIG. 6 is an explanatory diagram of the mode D. The mode D is a method of multiplexing the HD-SDIs of eight channels (CH1 to CH8). In the mode D, respective data pieces of the video data areas and the horizontal auxiliary data space of the 10.692 Gbps stream are multiplexed. At this time, the video/EAV/SAV data pieces of the HD-SDIs of the channels CH1, CH3, CH5 and CH7 are extracted by 40 bits, and are scrambled so as to be converted into data of 40 bits. Meanwhile, the video/EAV/SAV data of the HD-SDIs of the channels CH2, CH4, CH6 and CH8 are extracted by 32 bits, and are converted into data of 40 bits by 8B/10B conversion. The respective data pieces are added to each other to form data of 80 bits. The encoded 8-word (80-bit) data is multiplexed into the video data area of the 10.692 Gbps stream.

At this time, to the first-half data block of 40 bits from within the data block of 80 bits, the data block of 40 bits of the even-numbered channels obtained by the 8B/10B conversion can be allocated. Then, to the latter-half data block of 40 bits, the data block of scrambled 40 bits of the odd-numbered channels can be allocated. Therefore, in the single data block, for example, the data blocks are multiplexed in the order of, for example, the channels CH2 and CH1. The reason why the order is changed in this manner is that a content ID for identifying a mode to be used is included in the data block of 40 bits of the even-numbered channels obtained by the 8B/10B conversion.

Meanwhile, the horizontal auxiliary data space of the HD-SDI of the channel CH1 is subjected to 8B/10B conversion, and is encoded into a data block of 50 bits. Then, the data block is multiplexed into the horizontal auxiliary data space of the 10.692 Gbps stream. However, the horizontal auxiliary data spaces of the HD-SDIs of the channels CH2 to CH8 are not transmitted.

Next, a description will be given of an example of detailed processing of a process in which the mapping section 11 maps the pixel samples.

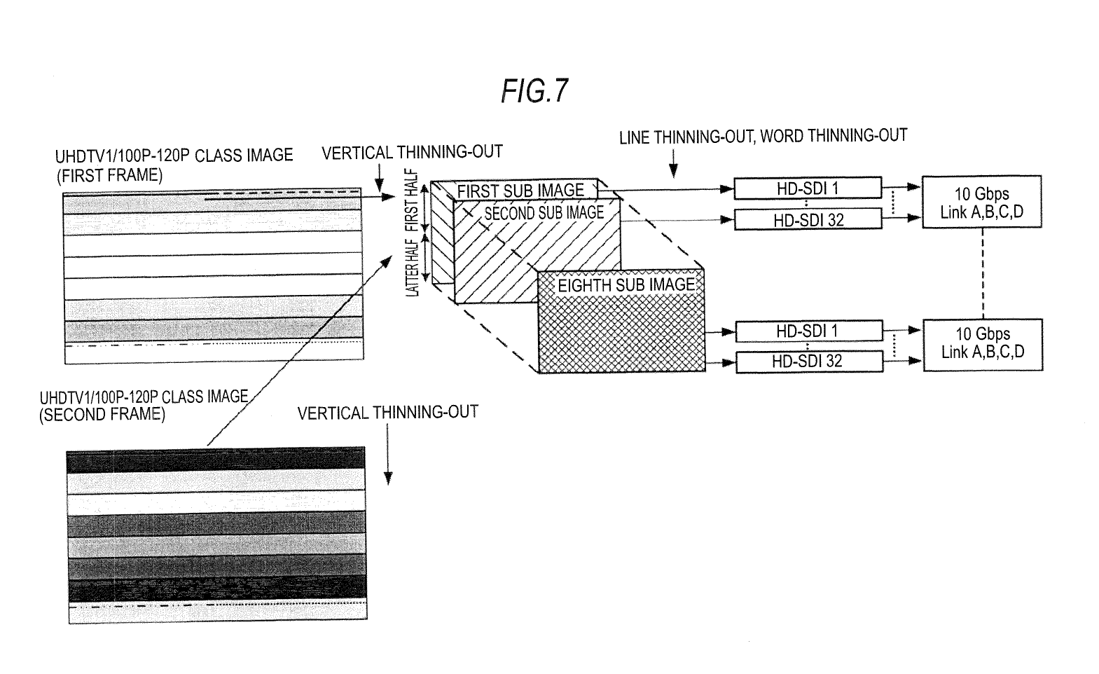

FIG. 7 is a diagram illustrating an example in which the mapping section 11 maps the pixel samples, which are included in the first and second frames which are successive UHDTV1 class images, into the first to eighth sub images and further maps the pixel samples into the HD-SDIs of 32 channels.

The horizontal rectangular area thinning-out control section 22 calculates first to eighth horizontal rectangular areas by dividing one frame (one screen) into eight pieces for each horizontal rectangular area of which the vertical width is 270 lines. On the basis of the horizontal rectangular areas, the 3840×2160/100P-120P/4:4:4, 4:2:2, 4:2:0/10-bit, 12-bit signal is mapped into the first to eighth sub images. The first to eighth sub images are the 1920×1080/50P-60P/4:4:4, 4:2:2, 4:2:0/10-bit, 12-bit signal.

At this time, the thinning-out is sequentially performed in the horizontal rectangular areas of units of 270 lines in the vertical direction from the UHDTV1 class image of the first frame in which one frame (one screen) is the 3840×2160/100P-120P/4:4:4, 4:2:2, 4:2:0/10-bit, 12-bit signal. Then, the pixel samples, which are included in the horizontal rectangular areas, are mapped into the first halves (1st to 540th lines of the video data areas) of the video data areas of the 1920×1080/50P-60P/4:4:4, 4:2:2, 4:2:0/10-bit, 12-bit signals of the eight channels.

Thereafter, the mapping section 11 thins out the pixel samples in the horizontal rectangular areas of units of 270 lines in the vertical direction from the UHDTV1 class image of the second frame. Then, the pixel samples, which are included in the horizontal rectangular areas, are mapped into the latter halves (541st to 1080th lines of the video data areas) of the video data areas of the 1920×1080/50P-60P/4:4:4, 4:2:2, 4:2:0/10-bit, 12-bit signals of the eight channels. Subsequently, by mapping the pixel samples into 1920 samples×1080 lines as the video data area of the HD image format, the first to eighth sub images are created. In the following description, the UHDTV1 class image of the first frame is referred to as a “first class image”, and the UHDTV1 class image of the second frame is referred to as a “second class image”.

Next, the line thinning-out control sections 24-1 to 24-8 perform the line thinning-out, and the word thinning-out control sections 26-1 to 26-16 perform the word thinning-out, thereby producing 1920×1080/23.98P-30P/4:2:2/10 bit signals of 32 channels. Then, the readout control section 28-1 to 28-32 read out the HD-SDIs 1 to 32, and thereafter output them through quad links of the links A, B, C, and D of 10 Gbps.

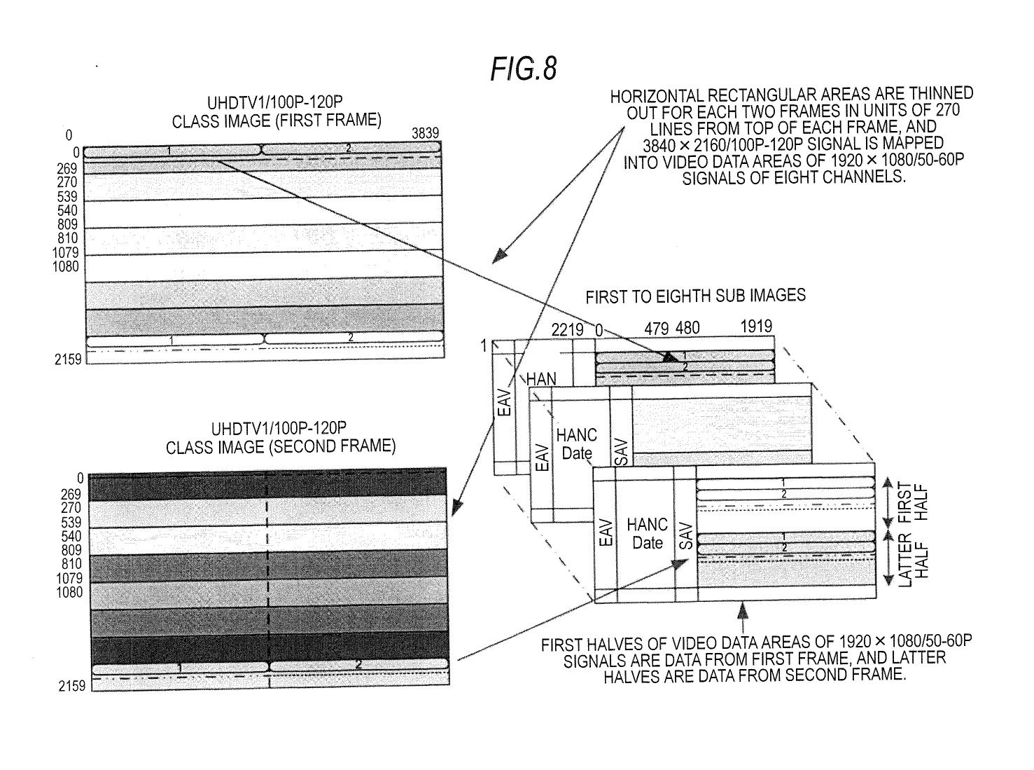

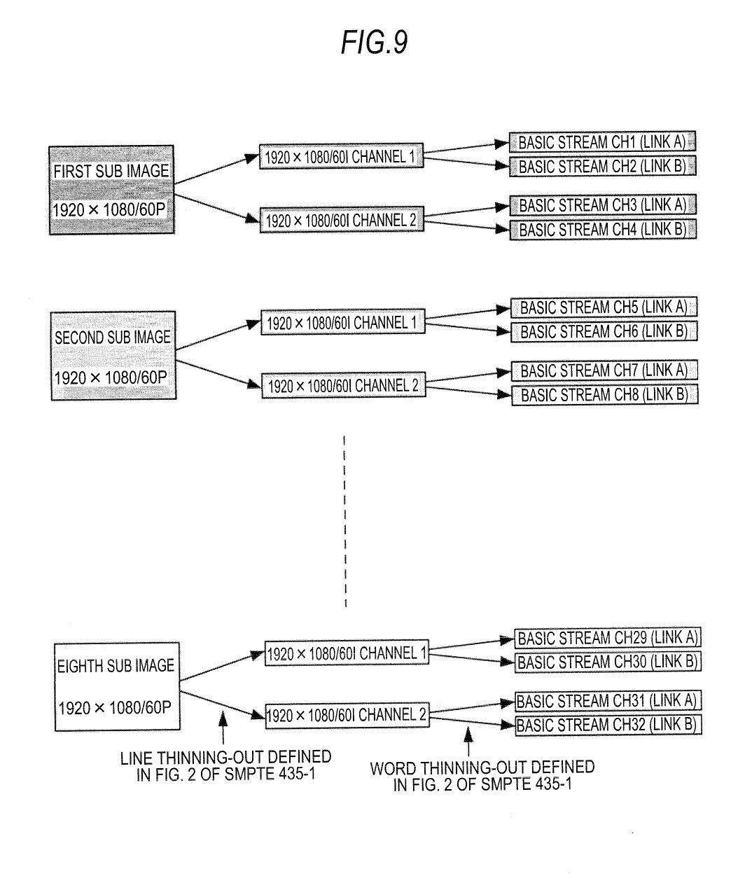

Next, referring to FIGS. 8 to 11, a description will be given of an example of the detailed processing which is performed when the respective processing blocks in the mapping section 11 maps the pixel samples.

FIG. 8 shows the example of the processing of mapping, into the first to eighth sub images, the pixel samples which are thinned out by the horizontal rectangular area thinning-out control section 21 in the horizontal rectangular areas of units of 270 lines in the vertical direction from the successive first and second class images.

The horizontal rectangular area thinning-out control section 21 maps the pixel samples of the 3840×2160/100P-120P/4:4:4, 4:2:2, 4:2:0/10-bit, 12-bit signals defined as the UHDTV1 class images into the first to eighth sub images. At this time, the mapping section 11 thins out the pixel samples in the vertical direction in the horizontal rectangular areas of units of 270 lines for every line of the UHDTV1 class images, and maps them into the first to eighth sub images.

The horizontal rectangular area thinning-out control section 21 thins out the 3840×2160/100P-120P/4:4:4, 4:2:2, 4:2:0/10-bit, 12-bit signal, for each two frames, in units of 270 lines of the first to eighth horizontal rectangular areas in the vertical direction. Then, the thinned out pixel samples are multiplexed into the video data areas of the first to eighth sub images. The first to eighth sub images are defined by 1920×1080/50P-60P/4:4:4, 4:2:2, 4:2:0/10-bits, 12-bits of eight channels. In addition, the 3840×2160/100P-120P/4:4:4, 4:2:2, 4:2:0/10-bit, 12-bit signal is a signal of which the frame rate is twice that of the 3840×2160/50P-60P/4:4:4, 4:2:2, 4:2:0/10-bit, 12-bit signal prescribed by S2036-1. The 1920×1080/50P-60P is defined by the SMPTE 274M. The digital signal form such as the inhibition codes of the 3840×2160/100P-120P/4:4:4, 4:2:2, 4:2:0/10-bit, 12-bit signal is the same as the 1920×1080/50P-60P.

Here, the class image of the UHDTV1, of which the number of pixels of one frame is greater than the number of pixels prescribed by the HD-SDI format, is defined as follows. That is, the class image is defined by a m×n/a-b/r:g:b/10-bit, 12-bit signal (m and n representing m samples and n lines are positive integers, a and b are frame rates of progressive signals, and r, g, and b are signal ratios in a prescribed signal transmission method). In this example, the class image of the UHDTV1 has m×n of 3840×2160, a-b of 100P, 119.88P, or 120P, and r:g:b of 4:4:4, 4:2:2, or 4:2:0. The UHDTV1 class image contains pixel samples in the range of 0 to 2159 lines.

In addition, lines in the class image of the UHDTV1 are determined as the 0th line, 1st line, 2nd line, 3rd line, . . . , and 2159th line which are successive, and each width of the first to eighth horizontal rectangular areas thereof in the vertical direction is determined as 270 lines. The horizontal rectangular area thinning-out control section 21 thins out the pixel samples from the successive first and second UHDTV1 class images. Then, the pixel samples are mapped into the video data areas of the first to eighth sub images which are defined by a m′×n′/a′−b′/r′:g′:b′/10-bit, 12-bit signal. Here, m′ and n′ representing m′ samples and n′ lines are positive integers, a′ and b′ are frame rates of progressive signals, and r′, g′, and b′ are signal ratios in a prescribed signal transmission method.

Then, the horizontal rectangular area thinning-out control section 22 maps the pixel samples into the video data areas of the first to eighth sub images with m′×n′ of 1920×1080, a′−b′ of 50P-60P, and r′:g′:b′ of 4:4:4, 4:2:2, or 4:2:0. At this time, the control section calculates the first to t-th horizontal rectangular areas obtained by dividing each of successive first and second class images into t pieces in units of p lines (p is an integer equal to or greater than 1) in the vertical direction. Then, the horizontal rectangular area thinning-out control section 22 maps the pixel samples which are read out from the first and second class images in units of p lines in the vertical direction. This mapping processing is performed alternately, by p lines at a time, up to a p×m/m′ line in the vertical direction of each line in the video data area of each of the first to t-th sub images for each of the first to t-th horizontal rectangular areas. Subsequently, the mapping processing is repeated in order from the first class image to the second class image. At this time, the pixel samples, which are read out from the first class image, is mapped into each line of the video data areas of the first to t-th sub images in units of p×m/m′ lines. Thereafter, the pixel samples, which are read out from the second class image, is mapped into a line vertically subsequent to the line, into which the pixel samples are mapped, in units of p×m/m′ lines.

Specifically, for example, the pixel samples, which are included in 270 lines from the line 0 to line 269 of the first class image, are thinned out by dividing the pixel samples into two for each single line. Then, 0th to 1919th pixel samples of the pixel samples, which are divided into two for each line, are mapped into the 1st line in the video data area of the first sub image. Next, 1920th to 3839th pixel samples of the pixel samples, which are divided into two for each line, are mapped into the 2nd line in the video data area of the first sub image. Likewise, the pixel samples, which are included in 270 lines from the line 270 to line 539 of the first class image, are thinned out by dividing the pixel samples into two for each line, and are mapped into the video data area of the second sub image. Hereinafter, this processing is repeated until reaching the line 2159 of the first class image.

When all the pixel samples of the first class image are mapped into the first to eighth sub images, then the pixel samples of the second class image are mapped into the first to eighth sub images. This mapping processing is performed similarly to the mapping processing of the first class image, but there is a difference in that the pixel samples are mapped into the latter halves of the video data areas of the first to eighth sub images.

Specifically, the detailed processing for mapping is performed as follows.

(1) The pixel samples 0 to 1919 in the line 0 of 3840×2160/120P of the first frame is multiplexed into the line 0 of the video data area of the first sub image (the line 42 in conformity with S274).

(2) The pixel samples 1920 to 3839 in the line 0 of 3840×2160/120P of the first frame is multiplexed into the line 1 of the video data area of the first sub image (the line 43 in conformity with S274).

.

.

(539) The pixel samples 0 to 1919 in the line 269 of 3840×2160/120P of the first frame is multiplexed into the line 538 of the video data area of the first sub image (the line 580 in conformity with S274).

(540) The pixel samples 1920 to 3839 in the line 269 of 3840×2160/120P of the first frame is multiplexed into the line 539 of the video data area of the first sub image (the line 581 in conformity with S274).

(541) The pixel samples 0 to 1919 in the line 270 of 3840×2160/120P of the first frame is multiplexed into the line 0 of the video data area of the second sub image (the line 42 in conformity with S274).

(542) The pixel samples 1920 to 3839 in the line 270 of 3840×2160/120P of the first frame is multiplexed into the line 1 of the video data area of the second sub image (the line 43 in conformity with S274).

.

.

(1079) The pixel samples 0 to 1919 in the line 539 of 3840×2160/120P of the first frame is multiplexed into the line 538 of the video data area of the second sub image (the line 580 in conformity with S274).

(1080) The pixel samples 1920 to 3839 in the line 539 of 3840×2160/120P of the first frame is multiplexed into the line 539 of the video data area of the second sub image (the line 581 in conformity with S274).

(1081) The pixel samples 0 to 1919 in the line 540 of 3840×2160/120P of the first frame is multiplexed into the line 0 of the video data area of the third sub image (the line 42 in conformity with S274).

(1082) The pixel samples 1920 to 3839 in the line 540 of 3840×2160/120P of the first frame is multiplexed into the line 1 of the video data area of the third sub image (the line 43 in conformity with S274).

.

.

(1619) The pixel samples 0 to 1919 in the line 809 of 3840×2160/120P of the first frame is multiplexed into the line 538 of the video data area of the third sub image (the line 580 in conformity with S274).

(1620) The pixel samples 1920 to 3839 in the line 809 of 3840×2160/120P of the first frame is multiplexed into the line 539 of the video data area of the third sub image (the line 581 in conformity with S274).

(1621) The pixel samples 0 to 1919 in the line 810 of 3840×2160/120P of the first frame is multiplexed into the line 0 of the video data area of the fourth sub image (the line 42 in conformity with S274).

(1622) The pixel samples 1920 to 3839 in the line 810 of 3840×2160/120P of the first frame is multiplexed into the line 1 of the video data area of the fourth sub image (the line 43 in conformity with S274).

.

.

(2159) The pixel samples 0 to 1919 in the line 1079 of 3840×2160/120P of the first frame is multiplexed into the line 538 of the video data area of the fourth sub image (the line 580 in conformity with S274).

(2160) The pixel samples 1920 to 3839 in the line 1079 of 3840×2160/120P of the first frame is multiplexed into the line 539 of the video data area of the fourth sub image (the line 581 in conformity with S274).

(2161) The pixel samples 0 to 1919 in the line 1080 of 3840×2160/120P of the first frame is multiplexed into the line 0 of the video data area of the fifth sub image (the line 42 in conformity with S274).

(2162) The pixel samples 1920 to 3839 in the line 1080 of 3840×2160/120P of the first frame is multiplexed into the line 1 of the video data area of the fifth sub image (the line 43 in conformity with S274).

.

.

(2698) The pixel samples 0 to 1919 in the line 1349 of 3840×2160/120P of the first frame is multiplexed into the line 538 of the video data area of the fifth sub image (the line 580 in conformity with S274).

(2699) The pixel samples 1920 to 3839 in the line 1349 of 3840×2160/120P of the first frame is multiplexed into the line 539 of the video data area of the fifth sub image (the line 581 in conformity with S274).

(2700) The pixel samples 0 to 1919 in the line 1350 of 3840×2160/120P of the first frame is multiplexed into the line 0 of the video data area of the sixth sub image (the line 42 in conformity with S274).

(2701) The pixel samples 1920 to 3839 in the line 1350 of 3840×2160/120P of the first frame is multiplexed into the line 1 of the video data area of the sixth sub image (the line 43 in conformity with S274).

.

.

(3238) The pixel samples 0 to 1919 in the line 1619 of 3840×2160/120P of the first frame is multiplexed into the line 538 of the video data area of the sixth sub image (the line 580 in conformity with S274).

(3239) The pixel samples 1920 to 3839 in the line 1619 of 3840×2160/120P of the first frame is multiplexed into the line 539 of the video data area of the sixth sub image (the line 581 in conformity with S274).

(3240) The pixel samples 0 to 1919 in the line 1620 of 3840×2160/120P of the first frame is multiplexed into the line 0 of the video data area of the seventh sub image (the line 42 in conformity with S274).

(3241) The pixel samples 1920 to 3839 in the line 1620 of 3840×2160/120P of the first frame is multiplexed into the line 1 of the video data area of the seventh sub image (the line 43 in conformity with S274).

.

.

(3778) The pixel samples 0 to 1919 in the line 1889 of 3840×2160/120P of the first frame is multiplexed into the line 538 of the video data area of the seventh sub image (the line 580 in conformity with S274).

(3779) The pixel samples 0 to 1919 in the line 1889 of 3840×2160/120P of the first frame is multiplexed into the line 539 of the video data area of the seventh sub image (the line 581 in conformity with S274).

(3780) The pixel samples 0 to 1919 in the line 1890 of 3840×2160/120P of the first frame is multiplexed into the line 0 of the video data area of the eighth sub image (the line 42 in conformity with S274).

(3781) The pixel samples 1920 to 3839 in the line 1890 of 3840×2160/120P of the first frame is multiplexed into the line 1 of the video data area of the eighth sub image (the line 43 in conformity with S274).

.

.

(4318) The pixel samples 0 to 1919 in the line 2159 of 3840×2160/120P of the first frame is multiplexed into the line 538 of the video data area of the eighth sub image (the line 580 in conformity with S274).

(4319) The pixel samples 1920 to 3839 in the line 2159 of 3840×2160/120P of the first frame is multiplexed into the line 539 of the video data area of the eighth sub image (the line 581 in conformity with S274).

.

.

In such a manner, the horizontal rectangular area thinning-out control section 22 maps the pixel samples, which are read out in the horizontal rectangular areas of units of 270 lines in the vertical direction from each line of the first class image, into the first halves of the video data areas of the first to eighth sub images. At this time, the pixel samples are mapped into the video data areas of the first to eighth sub images in the alignment order of the horizontal rectangular areas in the first class image.

Likewise, the horizontal rectangular area thinning-out control section 22 maps the pixel samples, which are read out in the horizontal rectangular areas of units of 270 lines in the vertical direction from each line of the second class image, into the latter halves of the video data areas of the first to eighth sub images. Note that, in a case of the 4:2:0 signal, the 0 signal allocates a default value. In addition, in a case of 10 bits, 200h is allocated as a default value, and in a case of 12 bits, 800h is allocated as a default value.

Note that, when the pixel samples are thinned out in units of 270 lines in the vertical direction for each successive two frames, the number of pixel samples, which are thinned out and mapped into the sub images, is represented by 3840÷2=1920 samples.

Further, when the pixel samples, which are included in each line divided into two by thinning out the horizontal rectangular areas in the vertical direction for each two frames, are mapped, the number of lines of the sub images, into which the pixels are multiplexed, is represented by 2160÷8×2×2=1080 lines. Therefore, the number of lines and the number of pixel samples, which are thinned out from the first and second class images and multiplexed into the first to eighth sub images, are equal to those of the video data areas of the 1920×1080 sub images.

Next, the line thinning-out control sections 24-1 to 24-8 thin out the pixel samples for every other line of the first to eighth sub images, into which the pixel samples are mapped, so as to thereby produce interlaced signals.

Here, the mapping section 11 maps 200h (10-bit system) or 800h (12-bit system), which are default values of the C channel, to 0 of a 4:2:0 signal, and treats the signal of 4:2:0 as a signal equivalent to a signal of 4:2:2. Then, the first to eighth sub images are stored in the RAMS 23-1 to 23-8, respectively.

FIG. 9 shows an example in which the first to eighth sub images are subjected to the line thinning-out, are subsequently subjected to the word thinning-out, and are divided into a link A or a link B in conformity with the prescription of the SMPTE 372M.

The SMPTE 435 is a standard of a 10G interface. According to the prescription of the standard, the HD-SDI signals of a plurality of channels are converted into 50 bits by performing 8B/10B encoding in units of 40 bits, and are multiplexed for every channel. Further, according to the prescription of the standard, serial transmission is performed at the bit rate of 10.692 Gbps or 10.692 Gbps/1.001 (hereinafter simply referred to as 10.692 Gbps). The technique of mapping the 4 k×2 k signals into HD-SDI signals is shown in FIGS. 3 and 4 of 6.4 Octa link 1.5 Gbps Class of the SMPTE 435 Part 1.

In addition, the first to eighth sub images which are set as the 1920×1080/50P-60P/4:4:4, 4:2:2/10-bit, 12-bit signals, are subjected to line thinning-out in the method prescribed by FIG. 2 of the SMPTE 435-1. In this example, the line thinning-out control sections 24-1 to 24-8 thin out the 1920×1080/50P-60P signals, which form the first to eighth sub images, for every line so as to thereby produce the interlaced signals (1920×1080/50I-60I signals) of two channels. The 1920×1080/50I-60I/4:4:4, 4:2:2, 4:2:0/10-bit, 12-bit signal is a signal defined by the SMPTE 274M.

Thereafter, the word thinning-out control sections 26-1 to 26-16 further perform word thinning-out when the signals subjected to the line thinning-out are the 10-bit, 12-bit signals of 4:4:4 or the 12-bit signals of 4:2:2, and then the signals are transmitted through the respective 1.5 Gbps HD-SDIs of four channels. Here, the word thinning-out control sections 26-1 to 26-16 map the channels 1 and 2 including the 1920×1080/50I-60I signals into the links A and B in the following manner.

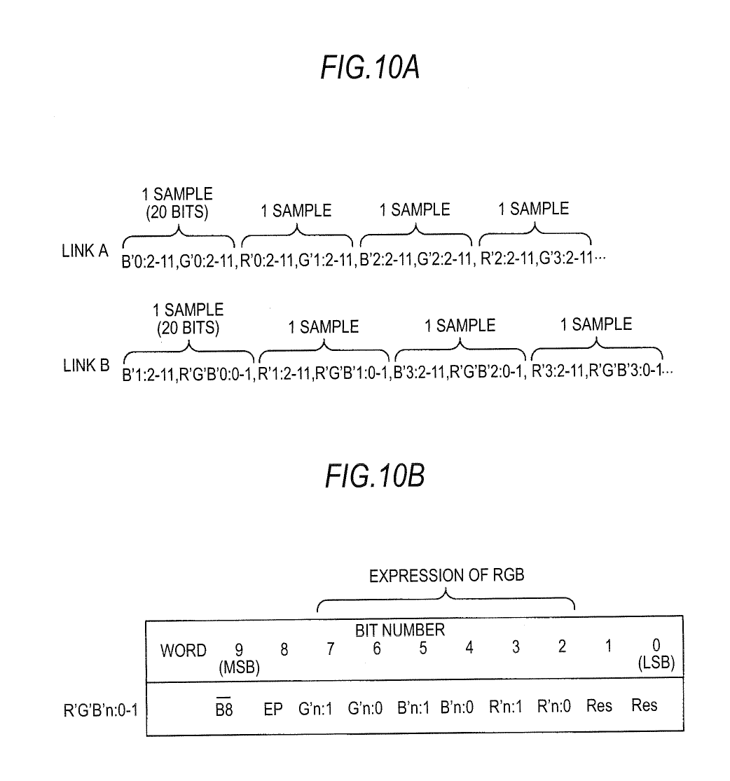

FIGS. 10A and 10B show examples of data structures of the links A and B based on the SMPTE 372.

As shown in FIG. 10A, in the link A, a single sample is 20 bits, and all the bits represent RGB values.

As shown in FIG. 10B, also in the link B, a single sample is 20 bits, but only six bits of bit numbers 2 to 7 in R′G′B′n:0-1 of 10 bits represent RGB values. Accordingly, the number of bits representing the RGB values in the single sample is 16 bits.

In the case of 4:4:4, the word thinning-out control sections 26-1 to 26-16 perform the mapping into the links A and B (HD-SDIs of two channels) in the method described in FIGS. 4A to 4C (10 bits) or FIG. 6 (12 bits) of the SMPTE S372.

In the case of 4:2:2, the word thinning-out control sections 26-1 to 26-16 do not use the link B, and use only CH1, CH3, CH5, and CH7.

Then, the readout control sections 28-1 to 28-32 multiplex the 3840×2160/100P-120P/4:4:4, 4:2:2, 4:2:0/10-bit, 12-bit signals into a transmission stream of 10.692 Gbps defined by the mode D of four channels, and transmit the signals. As the multiplexing method, the method disclosed in JP-A-2008-099189 is used.

In such a manner, the mapping section 11 generates the HD-SDIs of 32 channels from the first to eighth sub images. That is, the 3840×2160/100P-120P/4:4:4, 4:2:2, 4:2:0/10-bit, 12-bit signal can be transmitted through the HD-SDIs of a total of 32 channels. Note that, in the case of 4:2:2/10 bits, the transmission can be performed through the HD-SDIs of 16 channels.

The HD-SDI signals of CH1 to CH32 mapped by the mapping section 11 are sent to, as shown in FIG. 2, the S/P scramble 8B/10B section 12. Then, 8/10-bit encoded parallel digital data with 50 bits wide is written into a FIFO memory not shown in response to the clock of 37.125 MHz received from a PLL 13. Thereafter, the data is read out from the FIFO memory in a state where it has 50 bits wide in response to the clock of 83.5312 MHz received from a PLL 13, and is sent to the multiplexing section 14.

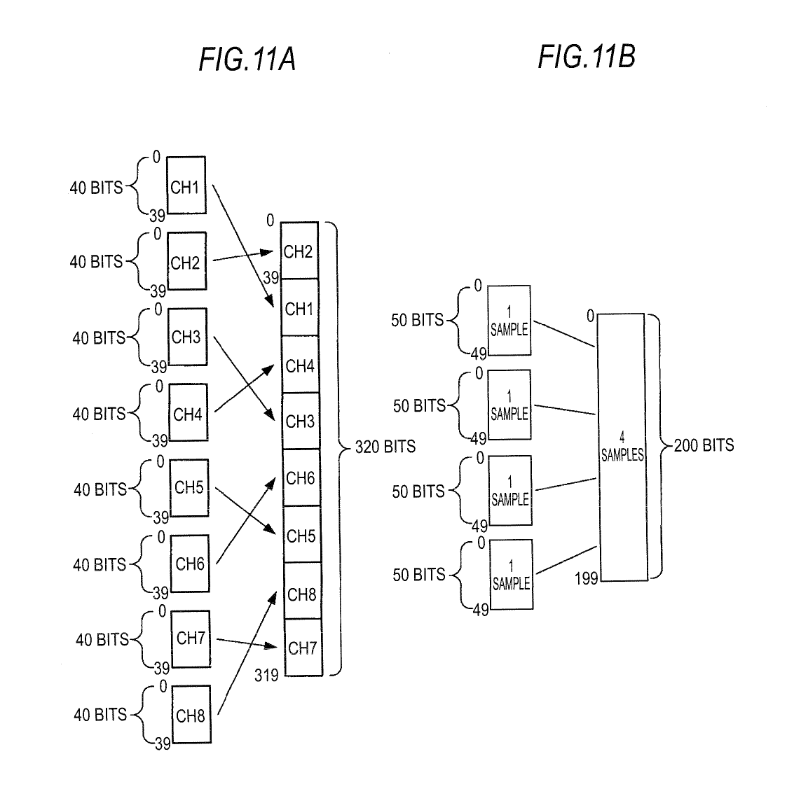

FIGS. 11A and 11B show examples of data multiplexing processing which is performed by the multiplexing section 14.

FIG. 11A shows a situation where each data of 40 bits of CH1 to CH8 scrambled is multiplexed into 320 bits wide in a state where the order of each pair of CH1 and CH2, CH3 and CH4, CH5 and CH6, and CH7 and CH8 is changed.

FIG. 11B shows a situation where the 50-bit/sample data subjected to 8B/10B conversion is multiplexed into the four samples with 200 bits wide.

As described above, the 8/10-bit encoded data is interleaved as data subjected to self-synchronizing scrambling for each 40 bits. Thereby, by eliminating variation in the mark rate (proportion between 1 and 0) caused by the scrambling method or instability in transitions of 0 to 1 and 1 to 0, it is possible to prevent a pathological pattern from occurring.

Further, the multiplexing section 14 multiplexes only the parallel digital data which is read out from the FIFO memory in the horizontal blanking period of CH1 in the S/P scramble 8B/10B section 12 and is 50 bits wide, into four samples so as to thereby make the data be 200 bits wide.

The parallel digital data with 320 bits wide multiplexed by the multiplexing section 14 and the parallel digital data with 200 bits are sent to a data length conversion section 15. The data length conversion section 15 is formed by using a shift register. Then, by using data with 256 bits wide into which the parallel digital data with 320 bits is converted and data with 256 bits wide into which the parallel digital data with 200 bits is converted, the parallel digital data with 256 bits is formed. Furthermore, the parallel digital data with 256 bits is converted into data with 128 bits wide.

The parallel digital data with 64 bits wide, which is sent from the data length conversion section 15 through the FIFO memory 16, is formed as serial digital data for 16 channels each having a bit rate of 668.25 Mbps by a multi-channel data formation section 17. The multi-channel data formation section 17 is, for example, an XSBI (Ten gigabit Sixteen Bit Interface: a 16-bit interface used as a system of 10 Gigabit Ethernet (registered trademark)). The serial digital data of 16 channels formed by the multi-channel data formation section 17 is sent to a multiplex-P/S conversion section 18.

The multiplex-P/S conversion section 18 has a function as a parallel/serial conversion section, and thus multiplexes the 16-channel serial digital data which is received from the multi-channel data formation section 17, and it parallel-to-serial converts the multiplexed parallel digital data. Thereby, serial digital data of 668.25 Mbps×16=10.692 Gbps are generated.

The serial digital data with a bit rate of 10.692 Gbps generated by the multiplex-P/S conversion section 18 is sent to a photoelectric conversion section 19. The photoelectric conversion section 19 functions as an output section for outputting the serial digital data with the bit rate of 10.692 Gbps to the CCU 2. Then, the photoelectric conversion section 19 outputs the transmission stream of 10.692 Gbps multiplexed by the multiplexing section 14. The serial digital data with the bit rate of 10.692 Gbps, which is converted into an optical signal by the photoelectric conversion section 19, is transmitted from the broadcast camera 1 to the CCU 2 through the optical fiber cable 3.

By using the broadcast camera 1 of the present example, the 3840×2160/100P-120P/4:4:4, 4:2:2, 4:2:0/10-bit, 12-bit signal, which is input from the image sensor, can be transmitted as serial digital data. In the signal transmission apparatus and the signal transmission method of the present example, the 3840×2160/100P-120P/4:4:4, 4:2:2, 4:2:0/10-bit, 12-bit signal is converted into the HD-SDI signals of CH1 to CH32. Thereafter, the signals are output as serial digital data of 10.692 Gbps.

Note that, not only the 3840×2160/100P-120P/4:4:4, 4:2:2, 4:2:0/10-bit, 12-bit signal is transmitted from each broadcast camera 1 to the CCU 2, but also the above-mentioned return video (a video signal for displaying a video during photography using another broadcast camera 1) is transmitted from the CCU 2 to each broadcast camera 1 through the optical fiber cable 3. The return video is produced by using the well-known technique (for example, the HD-SDI signals for two channels are respectively 8-bit/10-bit encoded, then multiplexed, and thereby converted into serial digital data), and thus a description of the circuit configuration thereof will be omitted.

### [Example of Internal Configuration and Operation of CCU]

Next, an example of the internal configuration of the CCU 2 will be described.

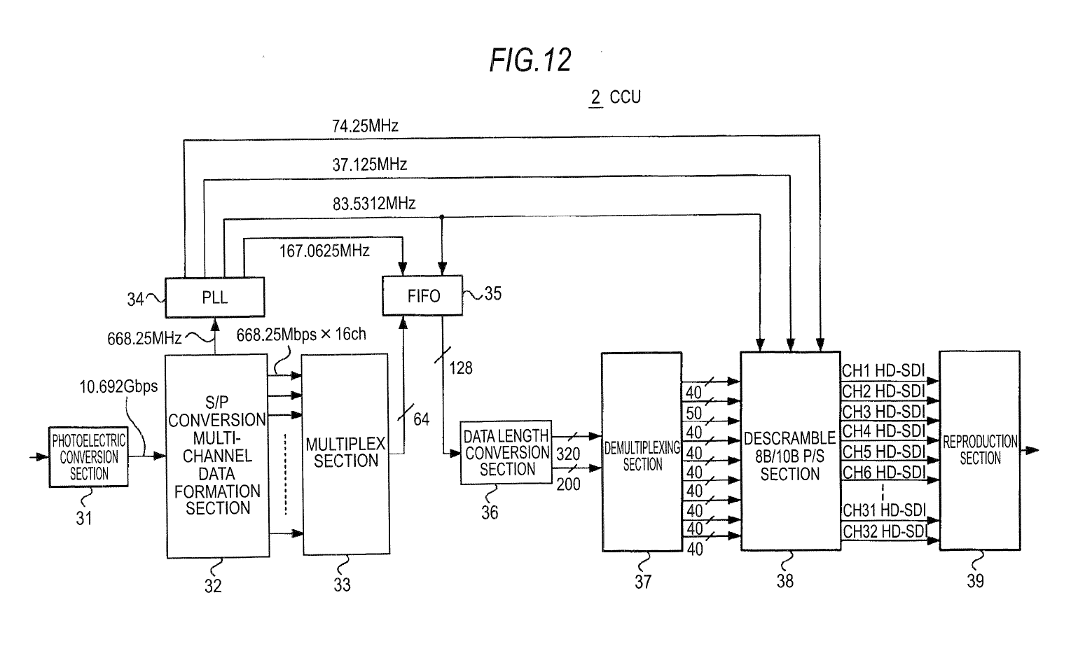

FIG. 12 is a block diagram illustrating a part of the circuit configuration of the CCU 2 which relates to the present embodiment. The CCU 2 includes a plurality of such circuits which correspond one-to-one with the broadcast cameras 1.

The serial digital data of the bit rate of 10.692 Gbps transmitted from each broadcast camera 1 through the optical fiber cable 3 is converted into an electric signal by the photoelectric conversion section 31, and then sent to an S/P conversion multi-channel data formation section 32. The S/P conversion multi-channel data formation section 32 is, for example, an XSBI. Then, the S/P conversion multi-channel data formation section 32 receives the serial digital data of the bit rate of 10.692 Gbps.

The S/P conversion multi-channel data formation section 32 performs serial/parallel conversion of the serial digital data of the bit rate of 10.692 Gbps. Then, the S/P conversion multi-channel data formation section 32 forms serial digital data for 16 channels each having the bit rate of 668.25 Mbps from the parallel digital data obtained by the serial/parallel conversion, and extracts a clock of 668.25 MHz.

The parallel digital data of 16 channels formed by the S/P conversion multi-channel data formation section 32 is sent to a multiplexing section 33. Meanwhile, the clock of 668.25 MHz extracted by the S/P conversion multi-channel data formation section 32 is sent to a PLL 34.

The multiplexing section 33 multiplexes the serial digital data of 16 channels which is received from the S/P conversion multi-channel data formation section 32, and sends the parallel digital data with 64 bits wide to a FIFO memory 35.

The PLL 34 divides the clock of 668.25 MHz, which is received from the S/P conversion multi-channel data formation section 32, by four so as to thereby produce a clock of 167.0625 MHz, and sends the clock of 167.0625 MHz as a write clock to the FIFO memory 35.

Further, the PLL 34 divides the clock of 668.25 MHz, which is received from the S/P conversion multi-channel data formation section 32, by eight so as to thereby produce a clock of 83.5312 MHz, and sends the clock of 83.5312 MHz as a readout clock to the FIFO memory 35. Furthermore, the PLL 34 sends the clock of 83.5312 MHz as a write clock to a FIFO memory in a descramble 8B/10B P/S section 38 to be described later.

Further, the PLL 34 divides the clock of 668.25 MHz, which is received from the S/P conversion multi-channel data formation section 32, by 18 so as to thereby produce a clock of 37.125 MHz, and sends the clock of 37.125 MHz as a readout clock to the FIFO memory in the descramble 8B/10B P/S section 38. Furthermore, the PLL 34 sends the clock of 37.125 MHz as a write clock to the FIFO memory in the descramble 8B/10B P/S section 38.

Further, the PLL 34 divides the clock of 668.25 MHz, which is received from the S/P conversion multi-channel data formation section 32, by 9 so as to thereby produce a clock of 74.25 MHz, and sends the clock of 74.25 MHz as a readout clock to the FIFO memory in the descramble 8B/10B P/S section 38.

In the FIFO memory 35, the parallel digital data with 64 bits wide received from the multiplexing section 33 is written in response to the clock of 167.0625 MHz received from the PLL 34. The parallel digital data written in the FIFO memory 35 is read out as parallel digital data with 128 bits wide in response to the clock of 83.5312 MHz received from the PLL 34, and sent to a data length conversion section 36.

The data length conversion section 36 is formed by using a shift register, and converts the parallel digital data with 128 bits wide into parallel digital data with 256 bits wide. Then, the data length conversion section 36 detects K28.5 inserted into the timing reference signal SAV or EAV. Thereby, the data length conversion section 36 discriminates each line period, and converts data of the timing reference signal SAV, active line, timing reference signal EAV, line number LN, and error detection code CRC into data with 320 bits wide. Further, the data length conversion section 36 converts data of the horizontal auxiliary data space (the data of the horizontal auxiliary data space of the channel CH1 obtained by the 8B/10B encoding) into data with 200 bits wide. The parallel digital data with 200 bits wide and the parallel digital data with 320 bits wide, which have the data lengths converted by the data length conversion section 36, are sent to a demultiplexing section 37.

The demultiplexing section 37 demultiplexes the parallel digital data with 320 bits wide, which is received from the data length conversion section 36, into data pieces of the channels CH1 to CH32 each having 40 bits before they are multiplexed by the multiplexing section 14 in the broadcast camera 1. The parallel digital data includes data of the timing reference signal SAV, active line, timing reference signal EAV, line number LN and error detection code CRC. Then, the 40-bit-wide parallel digital data pieces of the channels CH1 to CH32 are sent to the descramble 8B/10B P/S section 38.

Further, the demultiplexing section 37 demultiplexes the parallel digital data with 200 bits wide, which is received from the data length conversion section 36, into data pieces each having 50 bits before they are multiplexed by the multiplexing section 14. The parallel digital data includes data of the horizontal auxiliary data space of the channel CH1 8B/10B encoded. Then, the demultiplexing section 37 sends the 50-bit-wide parallel digital data to the descramble 8B/10B P/S section 38.

The descramble 8B/10B P/S section 38 is formed from 32 blocks corresponding one-to-one with the channels CH1 to CH32. The descramble 8B/10B P/S section 38 in the present example functions as a reception section for receiving the first to eighth sub images to which a video signal is mapped, and each of which is divided into a first link channel and a second link channel and divided into two lines.

The descramble 8B/10B P/S section 38 includes blocks for the channels CH1, CH3, CH5, CH7, . . . , CH31 of the link A, and descrambles the parallel digital data input thereto so as to thereby convert them into serial digital data, and outputs the data.

The descramble 8B/10B P/S section 38 further includes blocks for the channels CH2, CH4, CH6, CH8, . . . , CH32 of the links B, and decodes parallel digital data input thereto by 8B/10B decoding. Then, the descramble 8B/10B P/S section 38 converts the resulting data into serial digital data, and outputs the data.

A reproduction section 39 performs processing, which is reverse to the processing of the mapping section 11 in the broadcast camera 1, on HD-SDI signals of the channels CH1 to CH32 (link A and link B) sent from the descramble 8B/10B P/S section 38, in conformity with the SMPTE 435. Through this processing, the reproduction section 39 reproduces the 3840×2160/100P-120P/4:4:4, 4:2:2, 4:2:0/10-bit, 12-bit signal.

At this time, the reproduction section 39 reproduces the first to eighth sub images from the HD-SDIs 1 to 32 received by the S/P conversion multi-channel data formation section 32 by performing the word multiplexing, line multiplexing processing, and horizontal rectangular area multiplexing in order. Then, the reproduction section 39 reads out the pixel samples, which are disposed in the video data areas of the first to eighth sub images, by one line at a time for each 540 lines. The reproduction section 39 multiplexes the pixel samples for each 270 lines in the line direction of the first and second UHDTV1 class images which are the successive two frames.

The 3840×2160/100P-120P/4:4:4, 4:2:2, 4:2:0/10-bit, 12-bit signal reproduced by the reproduction section 39 is output from the CCU 2, and sent, for example, to a VTR and the like (not shown).

In the present example, the CCU 2 performs signal processing on the side which receives serial digital data produced by the broadcast cameras 1. In the signal reception apparatus and the signal reception method, the parallel digital data is produced from the serial digital data of the bit rate of 10.692 Gbps, and the parallel digital data is demultiplexed into data pieces of the individual channels of the link A and link B.

The demultiplexed data of the links A is subjected to self-synchronizing descrambling, and immediately prior to the timing reference signal SAV, all of the values of registers in a descrambler are set to 0 to start decoding. Further, self-synchronizing descrambling is applied also to data of at least several bits following the error detection code CRC. Thereby, self-synchronizing scrambling is applied only to data of the timing reference signal SAV, active line, timing reference signal EAV, line number LN, and error detection code CRC. Hence, although the data of the horizontal auxiliary data space is not subjected to self-synchronizing scrambling, it is possible to reproduce original data by performing accurate calculation taking the carry of the descrambler as a multiplication circuit into consideration.

Meanwhile, regarding the demultiplexed data of the link B, sample data of the link B are formed from the bits of RGB obtained by 8-bit/10-bit decoding. Then, the parallel digital data of the link A, to which the self-synchronizing descrambling is applied, and the parallel digital data of the link B, from which the samples are formed, are individually subjected to parallel/serial conversion. Then, the mapped HD-SDI signals of the channels CH1 to CH32 are reproduced.

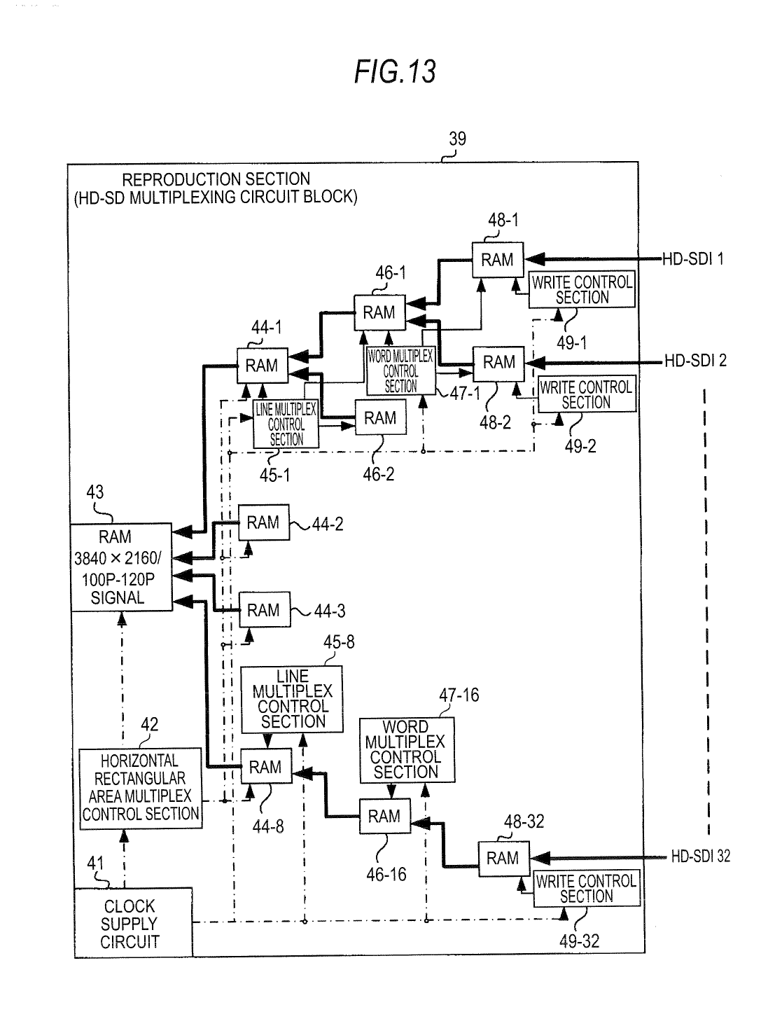

FIG. 13 shows an example of an internal configuration of the reproduction section 39.

The reproduction section 39 is a block in which the mapping section 11 performs reverse conversion to the processing performed on pixel samples.

The reproduction section 39 includes a clock supply circuit 41 for supplying clocks to the respective sections. The clock supply circuit 41 supplies a clock to the horizontal rectangular area multiplexing control section 42, line multiplexing control sections 45-1 to 45-8, word multiplexing control sections 47-1 to 47-16, and write control sections 49-1 to 49-32. The respective sections are synchronized with each other by the clock so that reading out or writing of pixel samples is controlled.

Further, the reproduction section 39 further includes RAMS 48-1 to 48-32 for respectively storing 32 HD-SDIs 1 to 32 in the mode D prescribed by the SMPTE 435-2. As described above, the HD-SDIs 1 to 32 constitute 1920×1080/50I-60I signals. For the HD-SDIs 1 to 32, the channels CH1, CH3, CH5, CH7, . . . , CH31 of the link A input from the descramble 8B/10B P/S section 38 and channels CH2, CH4, CH6, CH8, . . . , CH32 of the link B of the descramble 8B/10B P/S section 38 are used.

The write control sections 49-1 to 49-32 perform write control to store the input 32 HD-SDIs 1 to 32 in the RAMs 48-1 to 48-32 in response to a clock supplied thereto from the clock supply circuit 41.

Further, the reproduction section 39 includes word multiplexing control sections 47-1 to 47-16 for controlling word multiplexing (deinterleave), and RAMs 46-1 to 46-16 into which the data pieces multiplexed by the word multiplexing control sections 47-1 to 47-16 are written. Furthermore, the reproduction section 39 includes line multiplexing control sections 45-1 to 45-8 for controlling line multiplexing, and RAMs 44-1 to 44-8 into which the data pieces multiplexed by the line multiplexing control sections 45-1 to 45-8 are written.

The word multiplexing control sections 47-1 to 47-16 multiplex the pixel samples, which are extracted from the video data areas of the 10.692 Gbps stream determined by the mode D of four channels corresponding to each of the first to eighth sub images prescribed by the SMPTE 435-2, for each line. The word multiplexing control sections 47-1 to 47-16 multiplex the pixel samples, which are extracted from the video data regions of the HD-SDIs read out from the RAMs 48-1 to 48-32, for each line in which words are reversely converted in the FIGS. 4A to 4C, 6, 7, 8, and 9 of the SMPTE 372. Specifically, the word multiplexing control sections 47-1 to 47-16 control the timing for each of the RAMs 48-1 and 48-2, the RAMs 48-3 and 48-4, . . . , and the RAMs 48-31 and 48-32, thereby multiplexing the pixel sample. Then, the word multiplexing control sections 47-1 to 47-16 store the produced 1920×1080/50I-60I/4:4:4, 4:2:2, 4:2:0/10-bit, 12-bit signals in the RAMs 46-1 to 46-16.

The line multiplexing control sections 45-1 to 45-8 multiplex pixel samples, which are read out from the RAMs 46-1 to 46-16 and multiplexed for each line, for each sub image so as to thereby produce progressive signals. Then, the line multiplexing control sections 45-1 to 45-8 produce 1920×1080/50P-60P/4:4:4, 4:2:2, 4:2:0/10-bit, 12-bit signals, and store the signal in the RAMs 44-1 to 44-8. The signals stored in the RAMs 44-1 to 44-8 constitute the first to eighth sub images.

The horizontal rectangular area multiplexing control section 42 maps the pixel samples, which are extracted from the video data areas of the first to eighth sub images, into the successive first and the second class image of the UHDTV1. The first to eighth sub images have m′×n′ of 1920×1080, a′−b′ of 50P, 59.94P, and 60P, and r′:g′:b′ of 4:4:4, 4:2:2, or 4:2:0. At this time, the horizontal rectangular area multiplexing control section 42 multiplexes the pixel samples, which are readout as the horizontal rectangular areas for each 270 lines from the RAMs 44-1 to 44-8, into the UHDTV1 Class images. At this time, the horizontal rectangular area multiplexing control section 42 first reads out the pixel samples for each line from the first half of each of the first to eighth sub images. After reading out all the pixel samples from the first halves, the horizontal rectangular area multiplexing control section 42 reads out the pixel samples for each line from the latter half of each of the first to eighth sub images. The pixel samples are multiplexed in accordance with the class images of the UHDTV1. Each class image is a 3840×2160/100P-120P/4:4:4, 4:2:2, 4:2:0/10-bit, 12-bit signal.

Then, the horizontal rectangular area multiplexing control section 42 calculates first to t-th horizontal rectangular areas which are obtained by dividing each of successive first and second class images into t pieces (t=n/p) in units of p lines (p is an integer equal to or greater than 1) in the vertical direction. Subsequently, the pixel samples, which are read out up to a p×m/m′ line in the vertical direction in the video data areas of the first to t-th sub images, are alternately multiplexed into respective lines, each of which is divided into m/m′ pieces, in the first to t-th horizontal rectangular areas up to a p line in the first class image. The multiplexing processing is repeated in order from the first class image to the second class image. In this case, the pixel samples, which are read out from each line of the video data areas of the first to t-th sub images in units of p×m/m′ lines, is multiplexed into the first class image. Next, the pixel samples, which are read out in units of p×m/m′ lines from a line vertically subsequent to the line at which the pixel samples are read out from the video data areas of the first to t-th sub images, is multiplexed into the second class image.

Specifically, the horizontal rectangular area multiplexing control section 42 performs the following processing on the successive first and second class images. That is, 540 lines, which are read out in the vertical direction from the video data area of the first half of the first sub image, are multiplexed into the first horizontal rectangular area of the first class image. In this case, the horizontal rectangular area multiplexing control section 42 reads out two lines at a time from the first sub image, and sorts the two lines into a single line, thereby multiplexing them into the first class image. In the following lines in the first horizontal rectangular area of the first class image, the pixel samples are multiplexed in the range from line 0 to line 269 in which all the lines read out from the video data area of the first sub image correspond to 270 lines. When the first horizontal rectangular area in the first class image is filled with the pixel samples in the course of multiplexing the pixel samples, the pixel samples are multiplexed into the first horizontal rectangular area in the second class image. Hereinafter, the pixel samples are multiplexed up to the eighth class image.

Thereafter, the horizontal rectangular area multiplexing control section 42 multiplexes 540 lines, which are read out in the vertical direction from the video data area of the latter half of the first sub image, into the first horizontal rectangular area of the second class image. At this time, the horizontal rectangular area multiplexing control section 42 reads out two lines at a time from the first sub image, and sorts the two lines into a single line, thereby multiplexing them into the second class image. In the following lines in the first horizontal rectangular area of the second class image, the pixel samples are multiplexed in the range from line 0 to line 269 in which all the lines read out from the video data area of the first sub image correspond to 270 lines. When the first horizontal rectangular area in the second class image is filled with the pixel samples in the course of multiplexing the pixel samples, the pixel samples are multiplexed into the first horizontal rectangular area in the second class image. Hereinafter, the pixel samples are multiplexed up to the eighth class image.

Then, the RAM 43 stores the 3840×2160/100P-120P signal at the successive first and second frames defined by the UHDTV1 class image, and the signal is appropriately reproduced.

Note that, FIG. 13 shows an example in which the horizontal rectangular area multiplexing, the line multiplexing, and the word multiplexing are performed at three stages using three kinds of RAMs. However, alternatively a single RAM may be used to reproduce a 3840×2160/100P-120P/4:4:4, 4:2:2, 4:2:0/10-bit, 12-bit signal.

The mapping section 11 of the broadcast camera 1 according to the first embodiment mentioned above maps the 3840×2160/100P-120P signal with a large number of pixels defined by the UHDTV1 class image into the first to eighth sub images. The mapping processing is performed by performs the thinning-out in the horizontal rectangular areas of units of 270 lines for each successive two frames. Thereafter, by performing the line thinning-out and the word thinning-out, the HD-SDIs are output. The thinning-out processing is a method capable of minimizing the memory capacity which is necessary when the signal is mapped, and is a mode capable of minimizing the transmission delay of the signal by minimizing the memory capacity.

Meanwhile, after receiving the HD-SDIs of 32 channels, the reproduction section 39 of the CCU 2 performs the word multiplexing, the line multiplexing, thereby multiplexing the pixel samples into the first to eighth sub images. Thereafter, the 540 lines, which are extracted from the first to eighth sub images, are multiplexed into the 3840×2160 with a large number of pixels defined by the UHDTV1 class images of the successive two frames, in accordance with the horizontal rectangular areas of units of 270 lines. In such a manner, it is possible to transmit and receive the pixel samples defined by the UHDTV1 class image by using the HD-SDI format of the related art.

### Second Embodiment

### Example of the UHDTV2 7680×4320/100P, 119.88, 120P/4:4:4, 4:2:2, 4:2:0/10-Bit, 12-Bit

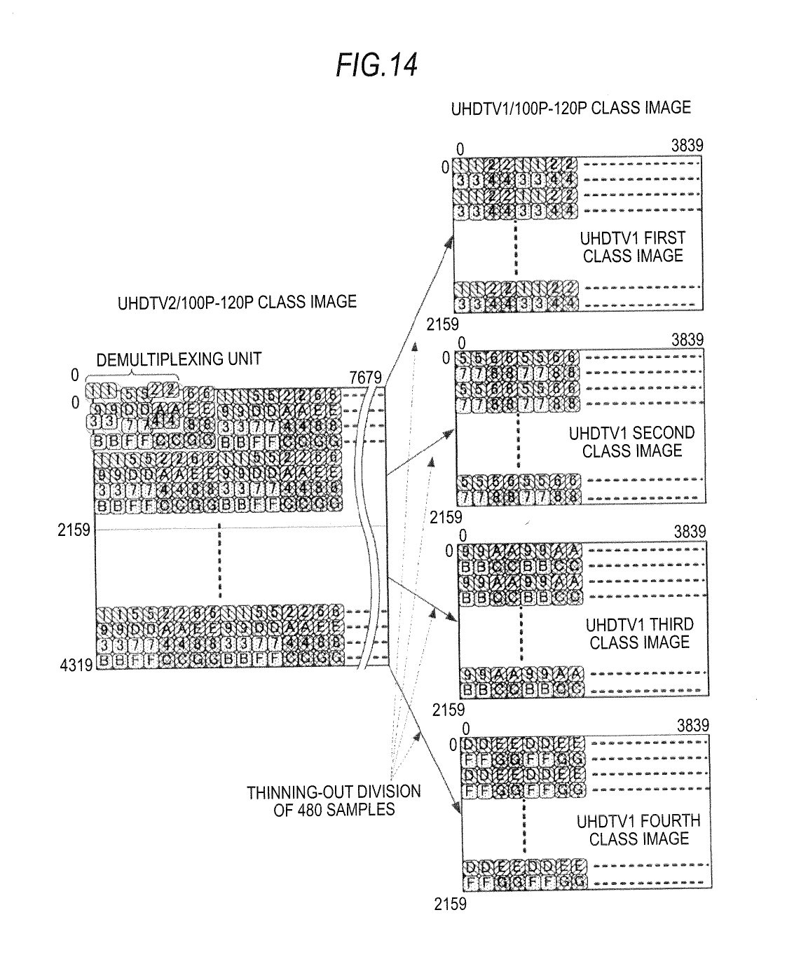

Hereinafter, an example of operations of the mapping section 11 and the reproduction section 39 according to a second embodiment of the present disclosure will be described with reference to FIGS. 14 to 16.

Here, a method of thinning out pixel samples of a 7680×4320/100P-120P/4:4:4, 4:2:2, 4:2:0/10-bit, 12-bit signal will be described.

FIG. 14 shows processing in which a mapping section 11 maps the pixel samples included in an UHDTV2 class image into UHDTV1 class images.

In the present example, a 7680×4320/100P-120P/4:4:4, 4:2:2, 4:2:0/10-bit, 12-bit signal defined by the UHDTV2 class image in which successive first and second lines are repeated is input to the mapping section 11. The 7680×4320/100P-120P/4:4:4, 4:2:2, 4:2:0/10-bit, 12-bit signal has a frame rate which is twice that of a signal prescribed by the S2036-1. The signal prescribed by the S2036-1 is a 7680×4320/50P-60P/4:4:4, 4:2:2, 4:2:0/10-bit, 12-bit signal. Further, the 7680×4320/100P-120P signal and the 7680×4320/50P-60P signal are same in the digital signal form of an inhibition code and the like.

The mapping section 11 first maps the 7680×4320/100P-120P/4:4:4, 4:2:2, 4:2:0/10-bit, 12-bit signal into the class image defined by the UHDTV1. This class image is a 3840×2160/100P-120P/4:4:4, 4:2:2, 4:2:0/10-bit, 12-bit signal.

The mapping section 11 maps the pixel samples into the first to fourth UHDTV1 class images from the UHDTV2 class image for every two pixel in units of two lines samples as prescribed in S2036-3. That is, the 7680×4320/100P-120P/4:4:4, 4:2:2, 4:2:0/10-bit, 12-bit signal is thinned out for every two pixel samples in units of two lines in the horizontal direction. Then, the pixel samples are mapped to 3840×2160/100P-120P/4:4:4, 4:2:2, 4:2:0/10-bit, 12-bit signals of four channels.

The 3840×2160/100P-120P/4:4:4, 4:2:2, 4:2:0/10-bit, 12-bit signals of four channels can be respectively transmitted in the mode D of 10.692 Gbps in four channels by such a method as described in the first embodiment. Therefore, the signals can be transmitted in the mode D of 10.692 Gbps in a total of 16 (=4×4) channels.

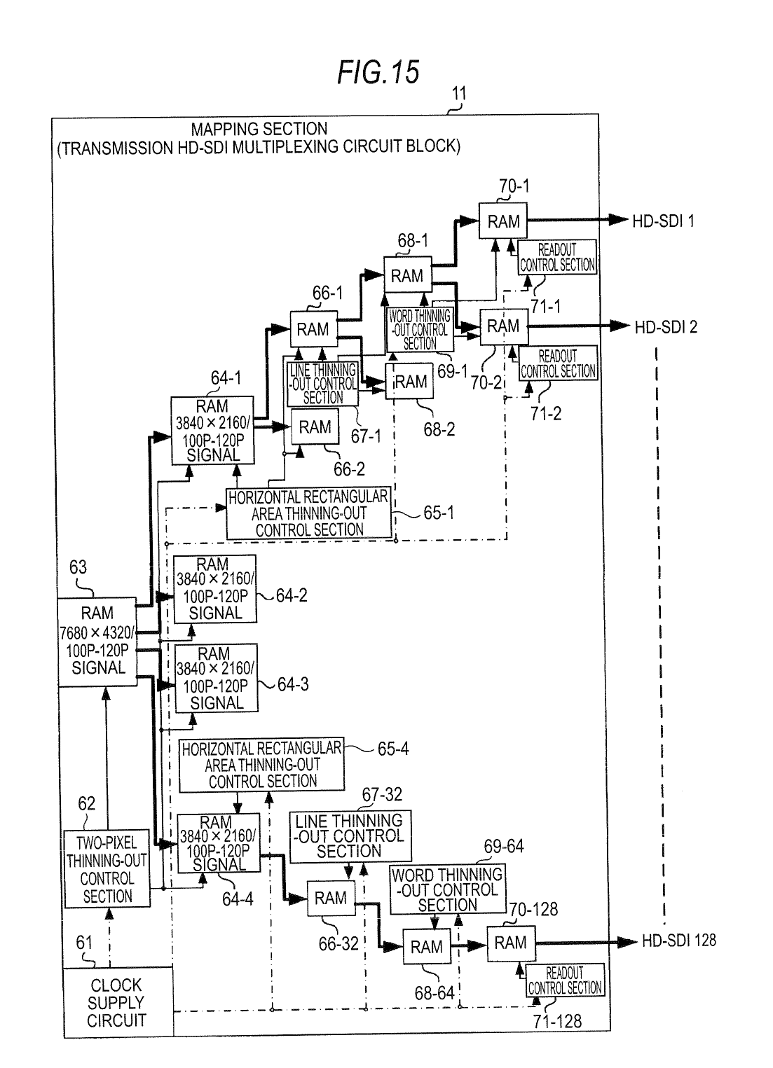

FIG. 15 shows an example of an internal configuration of the mapping section 11.

The mapping section 11 includes a clock supply circuit 61 for supplying a clock to the respective sections thereof, and a RAM 63 for storing a 7680×4320/100P-120P video signal. Further, the mapping section 11 includes a two-pixel-sample thinning-out control section 62 for controlling two-pixel-sample thinning-out (interleave) of reading out two pixel samples from the 7680×4320/100P-120P video signal as the UHDTV2 class image stored in the RAM 63. Further, the pixel samples, which are two-pixel-sample thinned out into the UHDTV1 class images, are stored in RAMs 64-1 to 64-4. The pixel samples are stored as first to fourth class images of the 3840×2160/100P-120P/4:4:4, 4:2:2, 4:2:0/10-bit, 12-bit signal defined by the UHDTV1.

Further, the mapping section 11 includes first horizontal rectangular area thinning-out control sections 65-1 to 65-4 for controlling horizontal rectangular area thinning-out of reading out pixel samples from the first to fourth class images which are read out from the RAMs 64-1 to 64-4. The horizontal rectangular area thinning-out control section 65-1 to 65-4 reads out the pixel samples in units of 270 lines for each successive two frames, and maps them into the first to eighth sub images. The operation of mapping the pixel samples to each of the sub images by the first horizontal rectangular area thinning-out control sections 65-1 to 65-4 is the same as the operation of the horizontal rectangular area thinning-out control section 21 according to the first embodiment mentioned above. The pixel samples subjected to the horizontal rectangular area thinning-out are stored as first to eighth sub images in RAMs 66-1 to 66-32 for each of the first to fourth class image.

Further, the mapping section 11 includes line thinning-out control sections 67-1 to 67-32 for performing line thinning-out of data read out from the RAMs 66-1 to 66-32, and RAMs 68-1 to 68-64 into which the data pieces thinned out by the line thinning-out control sections 67-1 to 67-32 are written.

Furthermore, the mapping section 11 includes word thinning-out control sections 69-1 to 69-64 for controlling word thinning-out of data read out from the RAMs 68-1 to 68-64. In addition, the mapping section 11 includes RAMs 70-1 to 70-128 into which the data pieces thinned out by the word thinning-out control sections 69-1 to 69-64 are written. Further, the mapping section 11 includes readout control sections 71-1 to 71-128 for outputting pixel samples of data read out from the RAMs 70-1 to 70-128 as HD-SDIs of 128 channels.

Note that, FIG. 15 shows those blocks for producing the HD-SDI 1, but also shows the blocks for producing the HD-SDIs 2 to 128 by using a similar configuration example, and thus illustration and detailed description thereof will be omitted.

Next, an operation example of the mapping section 11 will be described.

The clock supply circuit 61 supplies a clock to the two-pixel-sample thinning-out control section 62, horizontal rectangular area thinning-out control sections 65-1 and 65-4, line thinning-out control sections 67-1 to 67-32, word thinning-out control sections 69-1 to 69-64, and readout control sections 71-1 to 71-128. This clock is used for reading out or writing of pixel samples, and the respective sections are synchronized with each other by the clock.

The RAM 63 stores a class image defined by a 7680×4320/100P-120P/4:4:4, 4:2:2, 4:2:0/10-bit, 12-bit signal of the UHDTV2 input from an image sensor not shown.

The two-pixel-sample thinning-out control section 62 thins out two pixel samples adjacent to each other on the same line for each line from the class image of the UHDTV2 in which successive first and second lines are repeated. Then, the control section maps the two pixel samples into the first to the fourth class image of the UHDTV1. At this time, the control section maps every other third pixel sample, which is included in each of odd-numbered lines from the first line of the class images of the UHDTV2, into the same line in the first class image of the UHDTV1 for every line. Then, the control section maps each pixel sample which is included in each of the odd-numbered lines from the first line of the class images of the UHDTV2 and is different from the pixel samples mapped into the first class image of the UHDTV1. The mapping processing is performed for every other third pixel sample on the same line in the second class image of the UHDTV1. Next, the control section maps every other third pixel sample, which is included in each of even-numbered lines from the second line of the class images of the UHDTV2, into the same line in the third class image of the UHDTV1 for every line. Then, the control section maps each pixel sample which is included in each of the even-numbered lines from the second line of the class images of the UHDTV2 and is different from the pixel samples mapped into the third class image of the UHDTV1. The mapping processing is performed for every other third pixel sample on the same line in the fourth class image of the UHDTV1. The mapping processing is repeated until all the pixel samples of the UHDTV2 class image are extracted.

The processing of mapping the pixel samples into the first to eighth sub images by the horizontal rectangular area thinning-out control section 65-1 to 65-4, the line thinning-out processing, and the word thinning-out processing, which are performed thereafter, are performed in the same manner as the processing of thinning out the pixel samples according to the first embodiment. Thus, detailed description thereof will be omitted.

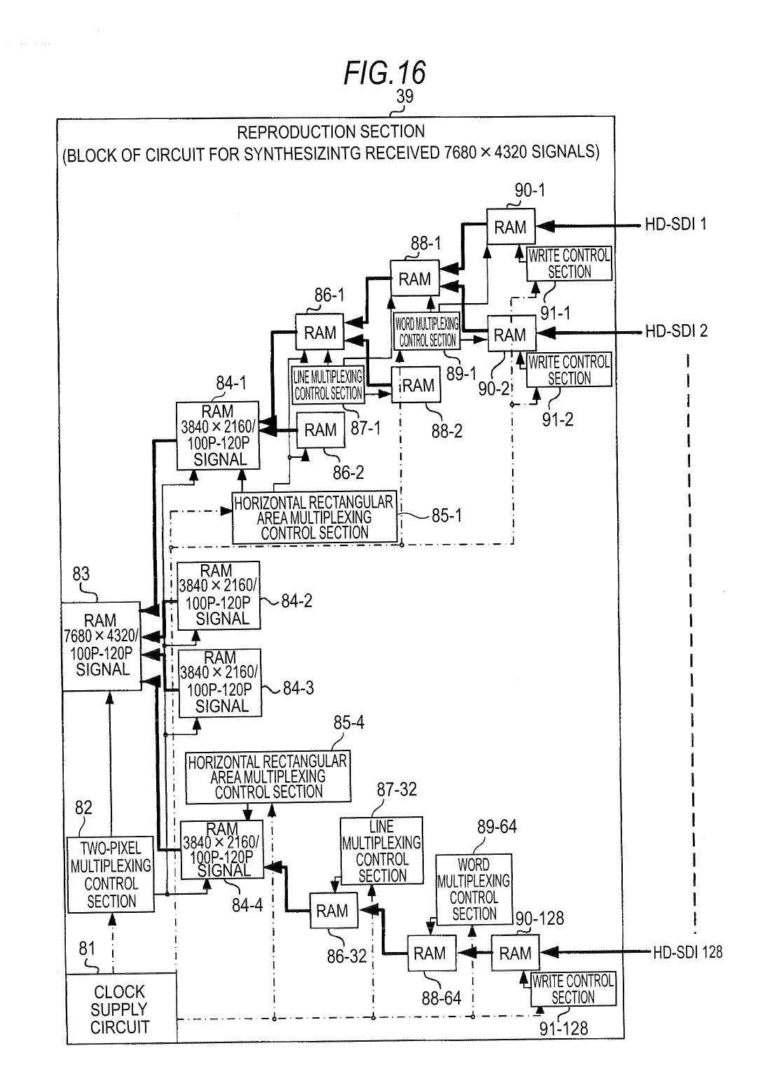

FIG. 16 shows an example of an internal configuration of the reproduction section 39.

The reproduction section 39 is a block for reverse conversion to that of the processing performed by the mapping section 11 on the pixel samples.

The reproduction section 39 includes a clock supply circuit 81 for supplying a clock to the respective sections thereof. Further, the reproduction section 39 includes RAMs 90-1 to 90-128 for respectively storing 128 HD-SDIs 1 to 128 which constitute 1920×1080/50I-60I signals. For the HD-SDIs 1 to 128, the channels CH1, CH3, CH5, CH7, . . . , CH127 of the link A and the channels CH2, CH4, CH6, CH8, . . . , CH128 of the link B input from the descramble 8B/10B P/S section 38 are used. Write control sections 91-1 to 91-128 perform control to write the 128 HD-SDIs 1 to 128 prescribed by the SMPTE 435-2 and input thereto into the RAMs 90-1 to 90-128 in response to the clock supplied thereto from the clock supply circuit 81.

Further, the reproduction section 39 includes word multiplexing control sections 89-1 to 89-64 for controlling word multiplexing (deinterleave), and RAMs 88-1 to 88-64 into which the data pieces multiplexed by the word multiplexing control sections 89-1 to 89-64 are written. Furthermore, the reproduction section 39 includes line multiplexing control sections 87-1 to 87-32 for controlling line multiplexing, and RAMs 86-1 to 86-32 into which the data pieces multiplexed by the line multiplexing control sections 87-1 to 87-32 are written.

Further, the reproduction section 39 includes horizontal rectangular area multiplexing control sections 85-1 to 85-4 for controlling processing of multiplexing the pixel samples of 540 lines, which are extracted from the RAMs 86-1 to 86-32, into the first and second class images for each horizontal rectangular area having 270 lines. Furthermore, the horizontal rectangular area multiplexing control sections 85-1 to 85-4 include RAMs 84-1 to 84-4 for storing the pixel samples multiplexed into the first to fourth UHDTV1 class images. Further, the reproduction section 39 includes a two-pixel multiplexing control section 82 for multiplexing the pixel samples of the first to fourth UHDTV1 class images, which are extracted from the RAMs 84-1 to 84-4, into the UHDTV2 class image. In addition, the reproduction section 39 includes a RAM 83 for storing the pixel samples multiplexed into the UHDTV2 class image.

Hereinafter, an operation example of the reproduction section 39 will be described.

The clock supply circuit 81 supplies a clock to the two-pixel multiplexing control section 82, horizontal rectangular area multiplexing control sections 85-1 to 85-4, line multiplexing control sections 87-1 to 87-32, word multiplexing control sections 89-1 to 89-64, and write control sections 91-1 to 91-128. By this clock, reading out or writing of pixel samples is controlled by the blocks synchronized with each other.

The processing of mapping the pixel samples extracted from the first to eighth sub images into the UHDTV1 class images, the line multiplexing processing, the word multiplexing processing are performed in the same manner as the processing of multiplexing the pixel samples according to the first embodiment. Thus, detailed description thereof will be omitted.

The two-pixel multiplexing control section 82 multiplexes the pixel samples, which are readout from the RAMS 84-1 to 84-4, for each two pixel samples through the following processing. That is, the two-pixel multiplexing control section 82 multiplexes the two pixel samples, which are extracted from the first to fourth class images of the UHDTV1, to positions of two pixel samples adjacent to each other on the same line for every line from class images of the UHDTV2 in which successive first and second lines are repeated. In this case, the control section multiplexes every other third pixel sample, which is extracted for each two pixel samples for every line from the same line in the first class image of the UHDTV1, on the same line which is each of odd-numbered lines from the first line of the class images of the UHDTV2. Next, the control section multiplexes pixel samples each of which is extracted for each two pixel samples for every line from the same line in the second class image of the UHDTV1. The multiplexing processing is performed for every other third pixel sample on the same line, which is each of the odd-numbered lines from the first line of the class images of the UHDTV2, at a position different from that of each pixel sample which is multiplexed from the first class image of the UHDTV1. Then, the control section multiplexes every other third pixel sample, which is extracted for each two pixel samples for every line from the same line in the third class image of the UHDTV1, on the same line which is each of even-numbered lines from the second line of the class images of the UHDTV2. Subsequently, the control section multiplexes pixel samples each of which is extracted for each two pixel samples for every line from the same line in the fourth class image of the UHDTV1. The multiplexing processing is performed for every other third pixel sample on the same line which is each of the even-numbered lines from the second line of the class images of the UHDTV2, at a position different from that of each pixel sample which is multiplexed from the third class image of the UHDTV1. The multiplexing processing is repeated until all the pixel samples of the UHDTV1 class image are extracted.

As a result, the 7680×4320/100-120P/4:4:4, 4:2:2, 4:2:0/10-bit, 12-bit signal as the class image defined by the UHDTV2 is stored in the RAM 83, and the signal is appropriately sent to the VTR and the like so as to be reproduced.

Note that, FIG. 16 shows an example in which the two-pixel multiplexing, the horizontal rectangular area multiplexing, the line multiplexing, and the word multiplexing are performed at four stages using four kinds of RAMs. However, alternatively a single RAM may be used to reproduce a 7680×4320/100P, 119.88, 120P/4:4:4, 4:2:2, 4:2:0/10-bit, 12-bit signal.

With the broadcast camera 1 according to the second embodiment mentioned above, the following thinning-out processing is performed. That is, a 7680×4320 signal with a large number of pixels is thinned out in a unit of two pixel samples, the pixel samples, which are thinned out for each horizontal rectangular area, are mapped into a plurality of 1920×1080 sub images, and then the line thinning-out is performed thereon. The thinning-out processing is a method capable of minimizing a memory capacity which is necessary when the signal is mapped, and is a mode capable of minimizing the transmission delay of the signal by minimizing the memory capacity.

Further, the CCU 2 according to the second embodiment performs the word multiplexing, the line multiplexing, the horizontal rectangular area multiplexing, and the two-pixel multiplexing on the basis of the 128 HD-SDIs which are received from the broadcast cameral, thereby producing the UHDTV1 class images. Furthermore, by producing the UHDTV2 class image from the UHDTV1 class images, it is possible to transmit the UHDTV2 class image by using the existing transmission interfaces between the CCU 2 and the broadcast camera 1.

Further, when 10G signals of 16 channels are intended to be transmitted by a single optical fiber, it is possible to use the CWDM/DWDM wavelength multiplexing technique. Note that, by combining two 4:2:0 signals into a 4:4:4 signal, it is possible to perform the transmission through 10G-SDIs of a half of the channels. That is, two sets of 4:2:0 signals are allocated to a signal corresponding to RGB 4:4:4. The Y signals of the two sets of 4:2:0 signals are allocated to the first 4(R) of the signal corresponding to 4:4:4, and Cb/Cr of each of the two sets of 4:2:0 signals is allocated to the next 4(G) thereof. Then, the Y signal of one set of the 4:2:0 signals is allocated to the last 4 (B) thereof, and the two sets of 4:2:0 signals are transmitted in a data format of the 4:4:4 signal, whereby it is possible to reduce the transmission capacity thereof by half.

### Third Embodiment

### Example of 3840×2160/(50P-60P)×N/4:4:4, 4:2:2, 4:2:0/10-Bit, 12-Bit

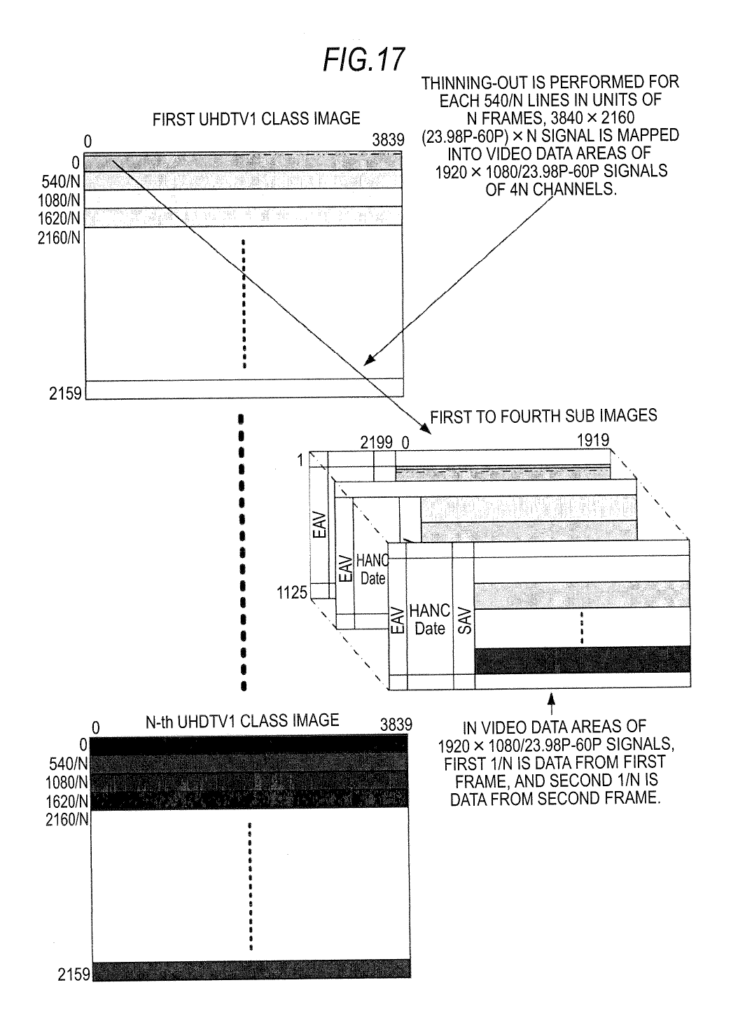

Hereinafter, an example of operations of the mapping section 11 and the reproduction section 39 according to a third embodiment of the present disclosure will be described with reference to FIG. 17.

FIG. 17 shows processing in which the mapping section 11 maps the pixel samples, which are included in successive first to N-th UHDTV1 class images, into first to 4N-th sub images (N is an integer equal to or greater than 2). The successive first to N-th class image of the UHDTV1 (successive first to N-th frames) including the first and second class images has m×n of 3840×2160. Then, a-b is defined as (50P, 59.94P, or 60P)×N, and r:g:b is defined as 4:4:4, 4:2:2, or 4:2:0. Further, lines of the first to N-th UHDTV1 class images is defined by 0 to 540/N, (540/N)+1 to 1080/N, . . . , or 2159. Since N is an integer equal to or greater than 2, (50P-60P)×N represents a video signal with a frame rate of 100P-120P in practice.

In this case, the mapping section 11 maps the pixel samples, which are included in the horizontal rectangular areas prescribed by the class image of the UHDTV1, for every (m/m′)×(n/4N) lines of the video data areas of the first to t-th sub images with t=4N. Note that, the following description will be given under the assumption that the first to t-th sub images are the first to 4N-th sub images. First to 4N-th video data areas have m′×n′ of 1920×1080, a′−b′ of 50P, 59.94P, or 60P, and r′:g′:b′ of 4:4:4, 4:2:2, or 4:2:0.

The 3840×2160/(50P-60P)×N/4:4:4, 4:2:2, 4:2:0/10-bit, 12-bit signal has an N times frame rate. The signal is a signal of which the frame rate is N times that of the 3840×2160/50P-60P/4:4:4, 4:2:2, 4:2:0/10-bit, 12-bit signal prescribed by S2036-1. However, even when the color gamut (Colorimetry) is different, the digital signal form such as inhibition codes is the same.

In the video data areas of the 1920×1080/50P-60P signals subjected to the mapping, a signal of the first frame of the 3840×2160/100P-120P/4:4:4, 4:2:2, 4:2:0/10-bit, 12-bit signal is mapped into 1/N part thereof. Then, the signal of the subsequent frame is mapped into the subsequent 1/N part, and thereafter the mapping processing is repeated until the video data areas of the first to 4N-th sub images are filled with the pixel samples.

Here, the mapping section 11 thins out the pixel samples of the 3840×2160/(50P-60P)×N/4:4:4, 4:2:2, 4:2:0/10-bit, 12-bit signal in the following manner. That is, the mapping section 11 sequentially extracts the pixel samples by 540/N lines at a time from each line of the horizontal rectangular areas in the UHDTV1 class image in units of successive N frames. Then, the 3840×2160/(50P-60P)×N/4:4:4, 4:2:2, 4:2:0/10-bit, 12-bit signal is mapped into the video data areas of the first to 4N-th sub images. The mapping processing is performed for every 540/N lines extracted from the upper part of the UHDTV1 class image. At this time, the mapping section 11 sequentially extracts the pixel samples of the horizontal rectangular areas for every 540/N lines from each frame of the UHDTV1 class image. Then, the 3840×2160/(50P-60P)×N/4:4:4, 4:2:2, 4:2:0/10-bit, 12-bit signal is multiplexed in order from 1/N line at the top of the video data areas of the first to 4N-th sub images to the subsequent 1/N line . . . .

Here, a single line of the first and second class images is formed of 3840 Pixel samples. Hence, when each single line read out from the first and second class images is not folded, it is difficult to perform the mapping into the first to 4N-th sub images of which the single line is 1920 Pixel samples.

The number of times of folding of the 1920 Pixel samples, which can be extracted from the 3840×2160/(50P-60P)×N/4:4:4, 4:2:2, 4:2:0/10-bit, 12-bit signal of the single line, is “2”.

That is, m/m′=3840/1920=2.

Further, the above-mentioned 540/N lines are calculated as follows. That is, in the present example, n/4N=2160/4N=540/N.

Hence, the pixel samples are multiplexed into the video data areas of the first to 4N-th sub images for each (m/m′)×(n/4N)=2×(540/N)=1080/N lines.

Further, the number of pixel samples subjected to the horizontal rectangular area thinning-out and the number of pixel samples subjected to the horizontal rectangular area thinning-out for each N frames are calculated in the following expression.

The number of pixel samples subjected to the horizontal rectangular area thinning-out=3840 Pixel samples÷2=1920 pixel samples

The number of lines subjected to the horizontal rectangular area thinning-out for each 4N frames=(540/N)×(2×N)=1080 lines

Thereby, the pixel samples can be mapped into 1920×1080/50P-60P/4:4:4, 4:2:2, 4:2:0/10-bit, 12-bit 4N channels prescribed by the SMPTE 274.

From this result, it can be seen that the pixel samples, which are thinned out from the first to N-th UHDTV1 class images, coincide with the video data areas of the 1920×1080 video signals as the first to 4N-th sub images.

The mapped 1920×1080/50P-60P signals of the 4N channels are divided into two 1920×1080/50I, 59.94I, 60I signals by performing the line thinning-out first as shown in FIG. 2 of the SMPTE 435-1. In the case of the 4:4:4/10-bit, 12-bit signal or the 4:2:2/12-bit signal, the word thinning-out is further performed thereon. At this time, the word thinning-out control section is prescribed in the SMPTE 435-1. Then, the readout control section transmits the signals through the respective 1.5 Gbps HD-SDIs of four channels which are read out from a RAM. Accordingly, the 3840×2160/(50P-60P)×N/4:4:4, 4:2:2, 4:2:0/10-bit, 12-bit signal can be transmitted through the HD-SDIs of a total of 16N channels. Note that, in the case of the 4:2:2/10-bit signal, it is possible to perform the transmission through the HD-SDIs of 8N channels.

In such a manner, the 3840×2160/(50P-60P)×N/4:4:4, 4:2:2, 4:2:0/10-bit, 12-bit signal can be mapped into the HD-SDIs of the 16N channels. Further, the 3840×2160/(50P-60P)×N/4:4:4, 4:2:2, 4:2:0/10-bit, 12-bit signal can be transmitted by multiplexing it at 10.692 Gbps in the 10G mode D of 2N channels. As the multiplexing method, the method disclosed in JP-A-2008-099189 is used. Note that, in the case of 4:2:2, the link B is not used, but only channels CH1, CH3, CH5, and CH7 are used. The example of the processing of mapping into the 10G-SDI, and the example of the configuration of the processing blocks of the transmission circuit and the reception circuit are the same as those of the above-mentioned embodiments.

Further, when intending to receive the HD-SDIs, the reproduction section 39 according to the third embodiment performs multiplexing processing. At this time, processing reverse to the processing performed by the mapping section 11 is performed. That is, the horizontal rectangular area multiplexing control section multiplexes the pixel samples, which are read out from the video data areas of the first to 4N-th sub images for each (m/m′)×(n/4N) lines, into the first to N-th class images for each n/4N lines. Thereby, the reproduction section 39 is able to multiplex the pixel samples into the first to N-th UHDTV1 class images.

Specifically, the word multiplexing control section and horizontal rectangular area multiplexing control section in the reproduction section 39 perform the following processing.

First, the word multiplexing control section according to the third embodiment multiplexes the pixel samples which are extracted from the video data areas of a 10.692 Gbps stream determined by a mode D of four channels corresponding to each of the first to 4N-th sub images. The first to 4N-th sub images are prescribed in the SMPTE 435-1, and are defined by m′×n′ of 1920×1080, a′−b′ of 50P, 59.94P, or 60P, and r′:g′:b′ of 4:4:4, 4:2:2, 4:2:0. Then, after the line multiplexing, the horizontal rectangular area multiplexing control section multiplexes the pixel samples, which are extracted from the video data areas of the first to 4N-th sub images, into the first to N-th class images. In this case, the pixel samples, which are extracted from the video data areas of the first to 4N-th sub images having the same number as the positions of the pixel samples defined in the class image of the UHDTV1, are multiplexed.

With the broadcast camera 1 according to the third embodiment mentioned above, the following thinning-out processing is performed. That is, an image signal, which is a 3840×2160 signal with a large number of pixels and of which the frame rate is N times 50P-60P, is thinned out in units of 540/N lines for each successive N frames, and the signal is mapped into the first to 4N-th 1920×1080 signals. Thereafter, the line thinning-out and the word thinning-out are performed. The thinning-out processing is a method capable of minimizing a memory capacity which is necessary when the signal is mapped, and is a mode capable of minimizing the transmission delay of the signal by minimizing the memory capacity.

Further, the CCU 2 according to the third embodiment performs the word multiplexing, the line multiplexing, and the horizontal rectangular area multiplexing on the basis of the 16N HD-SDIs which are received from the broadcast camera 1, thereby producing the UHDTV1 class images. In this case, the CCU 2 multiplexes the pixel samples, which are read out from the video data areas of the successive first to 4N-th 1920×1080 signals, into the first to N-th UHDTV1 class images.

### Fourth Embodiment

### Example of the UHDTV2 7680×4320/(50P-60P)×N/4:4:4, 4:2:2, 4:2:0/10-Bit, 12-Bit

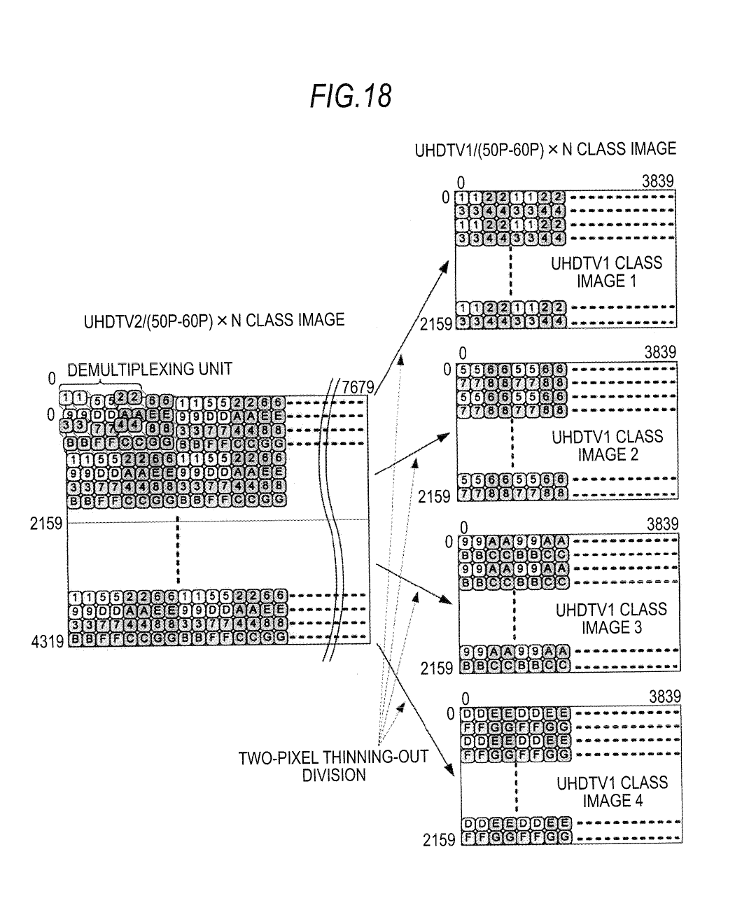

Hereinafter, an example of operations of the mapping section 11 and the reproduction section 39 according to a fourth embodiment of the present disclosure will be described with reference to FIG. 18.

FIG. 18 shows processing in which the mapping section 11 maps the pixel samples included in the UHDTV2 class image of which the frame rate is N times 50P-60P and in which the successive first and second lines are repeated. The mapping processing is performed on the UHDTV1 class images of which the frame rate is N times 50P-60P. Since N is an integer equal to or greater than 2, (50P-60P)×N represents a video signal with a frame rate of 100P-120P in practice.

The 7680×4320/(50P-60P)×N/4:4:4, 4:2:2, 4:2:0/10-bit, 12-bit signal has an N times frame rate. That is, the signal is a signal of which the frame rate is N times that of the 7680×4320/50P-60P/4:4:4, 4:2:2, 4:2:0/10-bit, 12-bit signal prescribed by S2036-1. However, even when the color gamut (Colorimetry) is different, the digital signal form such as inhibition codes is the same.

The two-pixel thinning-out control section 62 provided in the mapping section 11 maps the two pixel samples, which are adjacent to each other on the same line for every line from class images of the UHDTV2 in which successive first and second lines are repeated, into the first to fourth UHDTV1 class images. In this case, the control section maps every other third pixel sample, which is included in each of odd-numbered lines from the first line of the class images of the UHDTV2, into the same line in the first class image of the UHDTV1 for every line. Then, the control section maps each pixel sample which is included in each of the odd-numbered lines from the first line of the class images of the UHDTV2 and is different from the pixel samples mapped into the first class image of the UHDTV1. The mapping processing is performed for every other third pixel sample on the same line in the second class image of the UHDTV1. Next, the control section maps every other third pixel sample, which is included in each of even-numbered lines from the second line of the class images of the UHDTV2, into the same line in the third class image of the UHDTV1 for every line. Then, the control section maps each pixel sample which is included in each of the even-numbered lines from the second line of the class images of the UHDTV2 and is different from the pixel samples mapped into the third class image of the UHDTV1. The mapping processing is performed for every other third pixel sample on the same line in the fourth class image of the UHDTV1. In such a manner, the 7680×4320/(50P-60P)×N/4:4:4, 4:2:2, 4:2:0/10-bit, 12-bit signal is thinned out for every two pixels in units of two lines in the vertical direction. Then, the pixel samples are mapped into the 3840×2160/(50P-60P)×N/4:4:4, 4:2:2, 4:2:0/10-bit, 12-bit four channels.

The 3840×2160/(50P-60P)×N/4:4:4, 4:2:2, 4:2:0/10-bit, 12-bit four channels are subjected to the horizontal rectangular area thinning-out, the line thinning-out, and the word thinning-out, and are transmitted in the 10 Gbps mode D of 2N channels by the method according to the third embodiment. Hence, the broadcast camera 1 is able to transmit the 7680×4320/(50P-60P)×N/4:4:4, 4:2:2, 4:2:0/10-bit, 12-bit signal in the 10 Gbps mode D of a total of 8N channels.

Meanwhile, the reproduction section 39 receives the video signal which is transmitted in the 10 Gbps mode D of 8N channels. Then, the pixel samples are subjected to the word multiplexing, the line multiplexing, the two-pixel-sample multiplexing so as to thereby produce the first to 4N-th sub images. In this case, the pixel samples, which are extracted from each sub image, are multiplexed into the UHDTV1 class images from the first frame to the N-th frame. Then, the pixel samples, which are read out from the first to fourth UHDTV1 class images in the method according to the above-mentioned second embodiment, are multiplexed into the UHDTV2 class image.

That is, the two-pixel multiplexing control section 82 provided in the reproduction section 39 multiplexes the pixel samples, which are read out from the RAMs 84-1 to 84-4, for each two pixel samples through the following processing. That is, the two-pixel multiplexing control section 82 multiplexes the two pixel samples, which are extracted from the first to fourth class images of the UHDTV1, to positions of two pixel samples adjacent to each other on the same line for every line from class images of the UHDTV2 in which successive first and second lines are repeated. In this case, the control section multiplexes every other third pixel sample, which is extracted for each two pixel samples for every line from the same line in the first class image of the UHDTV1, on the same line which is each of odd-numbered lines from the first line of the class images of the UHDTV2. Next, the control section multiplexes pixel samples each of which is extracted for each two pixel samples for every line from the same line in the second class image of the UHDTV1. The multiplexing processing is performed for every other third pixel sample on the same line, which is each of the odd-numbered lines from the first line of the class images of the UHDTV2, at a position different from that of each pixel sample which is multiplexed from the first class image of the UHDTV1. Then, the control section multiplexes every other third pixel sample, which is extracted for each two pixel samples for every line from the same line in the third class image of the UHDTV1, on the same line which is each of even-numbered lines from the second line of the class images of the UHDTV2. Subsequently, the control section multiplexes pixel samples each of which is extracted for each two pixel samples for every line from the same line in the fourth class image of the UHDTV1. The multiplexing processing is performed for every other third pixel sample on the same line which is each of the even-numbered lines from the second line of the class images of the UHDTV2, at a position different from that of each pixel sample which is multiplexed from the third class image of the UHDTV1.

Thereby, the reproduction section 39 is able to reproduce the UHDTV2 class image from the UHDTV1 class images.

The mapping section 11 according to the above-mentioned fourth embodiment maps the video signals into the UHDTV1 images of 4N frames from the UHDTV2 class images of N frames with a frame rate N times 50P-60P. Thereafter, the line thinning-out and the word thinning-out are performed, and subsequently it is possible to transmit the video signals as the existing HD video signals.

Meanwhile, the reproduction section 39 according to the fourth embodiment performs the word multiplexing and the line multiplexing by using the received existing HD video signals so as to thereby produce the UHDTV1 images of 4N frames, and then multiplexes the pixel samples into the UHDTV2 class images of N frames. As described above, it is possible to promptly transmit the UHDTV2 class images of N frames with a frame rate N times 50P-60P by using the existing interfaces.

### Fifth Embodiment

### Example of 4096×2160/96P-120P/4:4:4, 4:2:2/10-Bit, 12-Bit

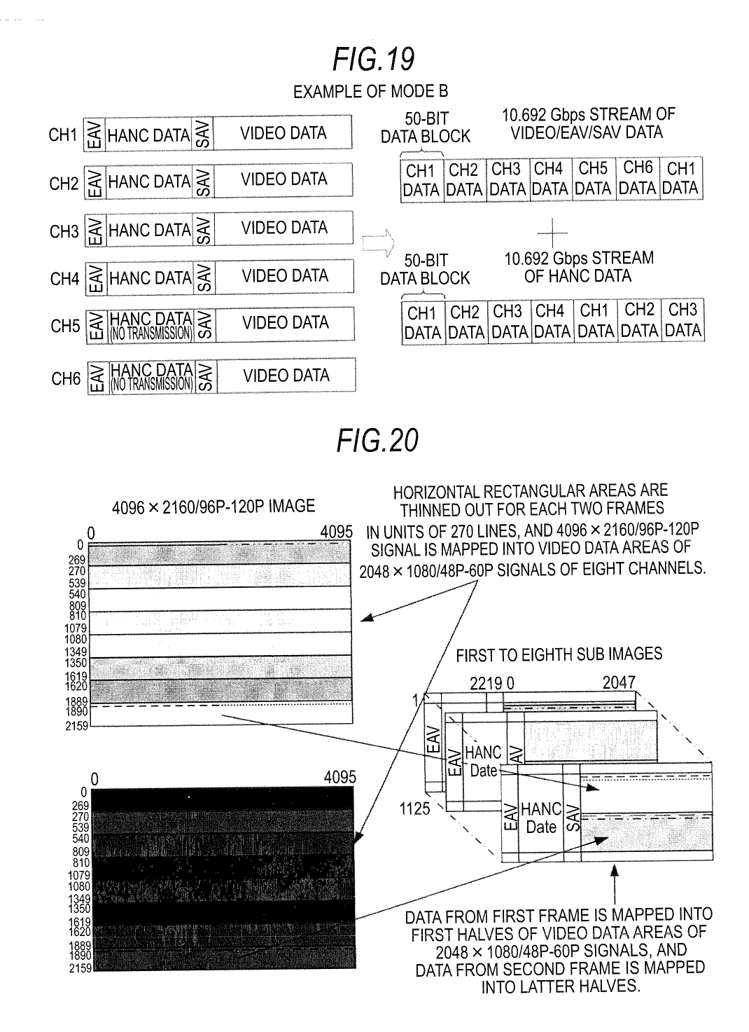

Hereinafter, an example of operations of the mapping section 11 and the reproduction section 39 according to a fifth embodiment of the present disclosure will be described with reference to FIGS. 19 to 21.

First, an example of a method of multiplexing data included in the HD-SDIs of a plurality of channels will be described with reference to FIG. 19. A method of multiplexing data is defined by the mode B in the SMPTE 435-2.

FIG. 19 is an explanatory diagram of the mode B.

The mode B is a method of multiplexing the HD-SDIs of six channels (CH1 to CH6).

In the mode B, respective data pieces of the video data areas and the horizontal auxiliary data space of the 10.692 Gbps stream are multiplexed. The video/EAV/SAV data pieces of four words included in the HD-SDIs of the six channels (CH1 to CH6) are subjected to 8B/10B conversion, and are encoded in the data block of five words (50 bits). Then, the data pieces are multiplexed into the video data areas of the 10.692 Gbps stream in order of channels from the head of the SAV.

Meanwhile, the horizontal auxiliary data spaces of the HD-SDIs of the four channels (CH1 to CH4) are subjected to the 8B/10B conversion, and are encoded into a data block of 50 bits. Then, the data pieces are multiplexed into the horizontal auxiliary data spaces of the 10.692 Gbps stream in the channel order. However, the horizontal auxiliary data spaces of the HD-SDIs of the channels CH5 and CH6 are not transmitted.

Hereinafter, a description will be given of an example in which the pixel samples of the 4096×2160/96P-120P/4:4:4, 4:2:2/10-bit, 12-bit signal are mapped into the first to t-th sub images (in the present example, t=8, and thus the sub images are assumed as first to eighth sub images).

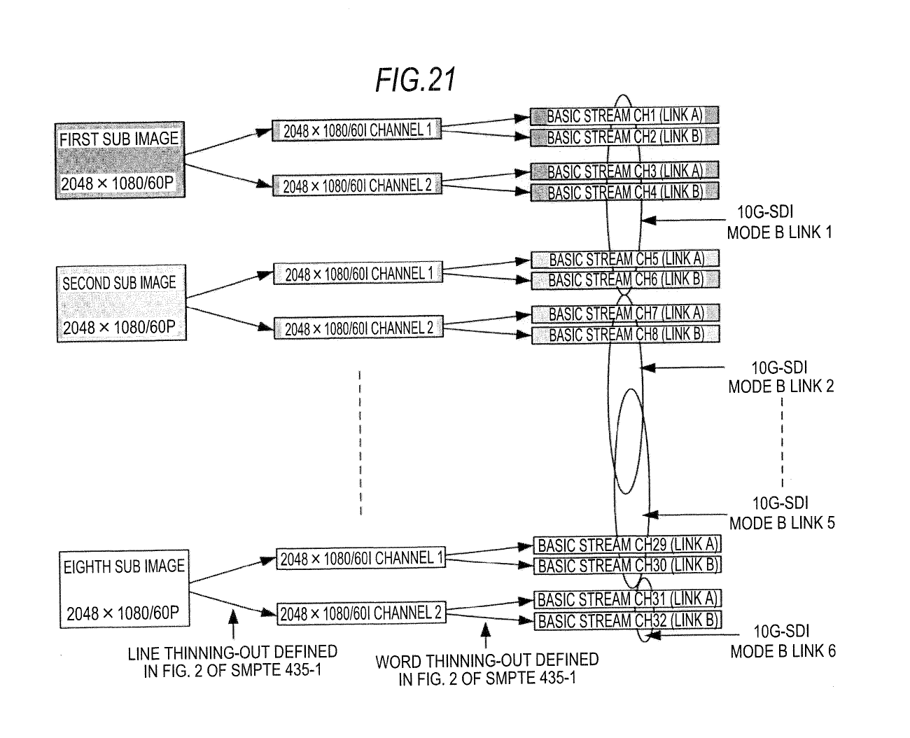

FIG. 20 shows processing in which the mapping section 11 maps the pixel samples included in a 4096×2160 class images, of which the frame rate is 96P-120P, into first to eighth sub images. Here, the 4096×2160 class image has m×n of 4096×2160, a-b of (47.95P, 48P, 50P, 59.94P, or 60P)×N (N is an integer equal to or greater than 2), and r:g:b of 4:4:4 or 4:2:2. Further, a description will be given of a case where the first and second class images are 4096×2160 class images.

The 4096×2160/96P-120P/4:4:4, 4:2:2/10-bit, 12-bit signal has a double frame rate. That is, the signal is a signal of which the frame rate is twice that of the 4096×2160/48P-60P/4:4:4, 4:2:2/10-bit, 12-bit signal prescribed by S2048-1. However, even when the color gamut (Colorimetry) is different, the digital signal form such as inhibition codes is the same.

The first and second 4096×2160 class images are input as video signals of successive two frames to the mapping section 11. The mapping section 11 thins out the pixel samples of the 4096×2160/96P-120P/4:4:4, 4:2:2/10-bit, 12-bit signal in order of the horizontal rectangular areas of each 270 lines from the first 4096×2160 class image. Then, the pixel samples of each 270 lines thinned out from the first 4096×2160 class image are mapped into the first half of each video data area of 2048×1080/48P-60P up to 540 lines. In this case, the horizontal rectangular area thinning-out control section maps the pixel samples into the video data areas of the first to eighth sub images. The first to eighth sub images has m′×n′ of 2048×1080, a′−b′ of 47.95P, 48P, 50P, 59.94P, or 60P, and r′:g′:b′ of 4:4:4 or 4:2:2. That is, the pixel samples are mapped into the 2048×1080/48P-60P/4:4:4, 4:2:2/10 bits, 12 bits of eight channels prescribed by the SMPTE 2048-2.

Further, the mapping section 11 thins out the pixel samples in order of the horizontal rectangular areas of each 270 lines from the second 4096×2160 class image. Then, the pixel samples of each 270 lines thinned out from the first 4096×2160 class image are mapped into the latter half of each video data area of 2048×1080/48P-60P up to 540 lines. Thereby, the pixel samples are respectively mapped into the 2048×1080/48P-60P/4:4:4, 4:2:2/10-bit, 12-bit eight channels prescribed by the SMPTE 2048-2.

It can be seen that the number of samples subjected to the horizontal rectangular area thinning-out and the number of lines subjected to the horizontal rectangular area thinning-out for each two frames are calculated in the following expression and those coincide with the video data areas of the 2048×1080 video signals.

The number of pixel samples subjected to the horizontal rectangular area thinning-out=4096÷2=2048 samples.

The number of lines subjected to the horizontal rectangular area thinning-out for each two frames=270×2×2=1080 lines.

The signal of the first frame of the 4096×2160/96P-120P/4:4:4, 4:2:2/10-bit, 12-bit signal is mapped into the first halves of the video data areas of the mapped 2048×1080/48P-60P signals, and the signal of the subsequent frame is mapped into the latter halves thereof.

FIG. 21 shows an example of processing of mapping the first to eighth sub images in the mode B by performing the line thinning-out and the word thinning-out.

Here, a description will be given of an example of processing of mapping the first to eighth sub images (2048×1080/60P/4:4:4/12 bit signal), into which the pixel samples are mapped, by dividing them into the link A or the link B in conformity with the prescription of the SMPTE 372M.

The SMPTE 435 is a standard of the 10G interface. The standard defines a way of multiplexing the HD-SDI signals of a plurality of channels for each channel by performing 8B/10B encoding on the signals in units of 40 bits and converting the signals into 50 bits. Further, the standard defines serial transmission using the bit rate of 10.692 Gbps or 10.692 Gbps/1.001 (hereinafter simply referred to as 10.692 Gbps). The technique of mapping the 4 k×2 k signal into the HD-SDI signals is shown in FIGS. 3 and 4 of 6.4 Octa link 1.5 Gbps Class of the SMPTE 435 Part 1.

The mapped 2048×1080/48P-60P signal of eight channels are divided into two 2048×1080/47.95P, 48P, 50I, 59.94I, 60I signals by performing the line thinning-out first as shown in FIG. 2 of the SMPTE 435-1. Thereafter, in the case of the 4:4:4 signal or the 4:2:2/12-bit signal, the word thinning-out is further performed thereon, and the signal is transmitted through 1.5 Gb/sHD-SDIs of four channels. Accordingly, the 4096×2160/96P-120P/4:4:4, 4:2:2/10-bit, 12-bit signal can be transmitted through the HD-SDIs of a total of 32 channels. Note that, in the case of the 4:2:2/10-bit signal, the signal is transmitted through the HD-SDIs of 16 channels.

In such a manner, the 4096×2160/96P-120P/4:4:4, 4:2:2/10-bit, 12-bit signal mapped into the HD-SDIs of 32 channels can be transmitted by multiplexing it at 10.692 Gbps in the mode B of six channels. As the multiplexing method, the method disclosed in JP-A-2008-099189 is used. Note that, in the case of 4:2:2, the link B is not used, but only channels CH1, CH3, CH5, and CH7 are used. The example of the processing of mapping into the 10G-SDI, and the example of the configuration of the processing blocks of the transmission circuit and the reception circuit are the same as those of the above-mentioned embodiments.

Further, the signal of the first frame of the 4096×2160/96P-120P/4:4:4, 4:2:2/10-bit, 12-bit signal is mapped into the first halves of the video data areas of the 2048×1080/48P-60P signals of the first to eighth sub images. Then, the signal of the subsequent frame is mapped into the latter halves thereof. Subsequently, the 2048×1080/48P-60P signals of eight channels, which are mapped into the first to eighth sub images, are subjected to the line thinning-out first as prescribed in FIG. 2 of the SMPTE 435-1, and are divided into two 2048×1080/48I-60I signals.

Then, when the 2048×1080/48I-60I signals are 4:4:4/10-bit, 12-bit or 4:2:2/12-bit signals, the signals are further subjected to the word thinning-out, and are subsequently transmitted through the HD-SDIs of 1.5 Gbps. The word thinning-out control section multiplexes the pixel samples into the video data areas of the 10.692 Gbps stream which is prescribed in the SMPTE 435-2 and is determined by the mode B of six channels corresponding to each of the first to eighth sub images. Accordingly, the 4096×2160/96P-120P/4:4:4, 4:2:2/10-bit, 12-bit signal is transmitted through the HD-SDIs of a total of 32 channels as shown in FIG. 20. Note that, in the case of 4:2:2/10 bits, the transmission can be performed through the HD-SDIs of 16 channels.

Specifically, the mapping section 11 converts the first to eighth sub images, which are set by the 2048×1080/48P-60P/4:4:4, 4:2:2/10-bit, 12-bit signals, into interlaced signals of 16 channels. Thereafter, the channels CH1 to CH32 based on the SMPTE 372M (dual links) are produced. The channels CH1 to CH32 are the channels CH1 (link A) and CH2 (link B), the channels CH3 (link A) and CH4 (link B), . . . and the channels CH31 (link A) and CH32 (link B). In the present example, the HD-SDI channels CH1 to CH6 are transmitted as a 10G-SDI mode B link 1. Likewise, the HD-SDI channels CH7 to CH12 are transmitted as a 10G-SDI mode B link 2, and the HD-SDI channels CH13 to CH18 are transmitted as a 10G-SDI mode B link 3. Further, the HD-SDI channels CH19 to CH24 are transmitted as a 10G-SDI mode B link 4, the HD-SDI channels CH25 to CH30 are transmitted as a 10G-SDI mode B link 5, and the HD-SDI channels CH31 to CH32 are transmitted as a 10G-SDI mode B link 6.

In such a manner, the HD-SDIs of 32 channels are mapped. Subsequently, the 4096×2160/96P-120P/4:4:4, 4:2:2/10-bit, 12-bit signal is transmitted by multiplexing it into six channels of the mode B of 10.692 Gbps. In the case of 4:2:2, the link B is not used, but only channels CH1, CH3, and CH5 are used.

Meanwhile, the reproduction section 39 performs processing reverse to the processing of the mapping section 11, thereby reproducing the 4096×2160/96P-120P/4:4:4, 4:2:2/10-bit, 12-bit signal. In this case, the word multiplexing control section multiplexes the pixel samples, which are extracted from the video data areas of the 10.692 Gbps stream prescribed in the SMPTE 435-2 and determined by the mode B of six channels corresponding to each of the first to eighth sub images, into lines. Then, the line multiplexing control section multiplexes two lines, thereby producing the first to eighth sub images. Further, the horizontal rectangular area multiplexing control section multiplexes the pixel samples, which are extracted from the video data areas of the first to eighth sub images, into the first and second 4096×2160 class images.

With the broadcast camera 1 according to the fifth embodiment mentioned above, the 4096×2160/96P-120P video signal is thinned out for each 270 lines in units of successive two frames. Then, the first to eighth sub images (2048×1080/48P-60P of eight channels) are mapped. Further, after the first to eighth sub images are subjected to the line thinning-out and the word thinning-out, it is possible to transmit the video signals by mapping the pixel samples into the links A and B of the 10G-SDI mode B of six channels.

Further, the CCU 2 according to the fifth embodiment mentioned above extracts the pixel samples from the 10G-SDI mode B link of six channels, and performs the word multiplexing and the line multiplexing, thereby producing the first to eighth sub images. Then, the pixel samples of 540 lines extracted from the first to eighth sub images are multiplexed into the 4096×2160/96P-120P video signal for each 270 lines in units of successive two frames. In such a manner, it is possible to transmit and receive the 4096×2160/96P-120P video signal.

Note that, in the mapping method according to the first to fifth embodiments mentioned above, the 3840×2160/100P-120P or 7680×4320/100P-120P signal, which is highly likely to be proposed in the future, is subjected to the horizontal rectangular area thinning-out. Thereafter, the line thinning-out is performed thereon, and finally the word thinning-out is performed thereon. Thereby, the signals can be mapped into the 1920×1080/50I-60I signals of multi-channels. As described above, in the mapping methods according to the first to fifth embodiment mentioned above, the necessary memory capacity is minimal, and the delay is also small. Further, the 1920×1080/50I-60I signal, which is prescribed by the SMPTE 274M, can be observed by an existing measuring equipment. Furthermore, the 3840×2160/100P-120P or 7680×4320/100P-120P signal is thinned out in units of pixels or by time, and the signal can be observed. In addition, since the methods complies with various existing SMPTE mapping standards, it has a high possibility that it may also be adopted in future standardization by the SMPTE.

The mapping methods according to the first to fifth embodiments mentioned above perform the following processing, and the multiplexing methods perform processing reverse thereto. That is, the 3840×2160/100P-120P signal, or the 7680×4320/100P-120P signal, or the 2048×1080/100P-120P signal, or the 4096×2160/96P-120P signal is thinned out. The thinning-out processing is performed for each p lines in units of successive two frames in the vertical direction. Thereafter, the pixel samples are multiplexed into the video data areas of the HD-SDIs of 1920×1080/50P-60P or 2048×1080/48P-60P, and are subsequently multiplexed at 10.692 Gbps in four channels, six channels, or 16 channels, whereby it is possible to perform transmission. In this case, it is possible to take the following advantages.

(1) In the ITU or SMPTE, the 3840×2160 and 7680×4320/100P-120P signals as next-generation video signals are being discussed. Further, the 4096×2160/96P-120P signal, the 3840×2160, 7680×4320/(50P-60P)×N signal, and the 4096×2160/(48P-60P)×N signal more than the signals are also being discussed. In addition, by using the method disclosed in Japanese Patent No. 4645638, it is possible to transmit the video signals through 10G interfaces of multi-channels.

(2) In the existing HD video standard SMPTE 274 and the 2048×1080 and 4096×2160 Digital Cinematography Production image Formats FS/709S2048-1 and 2, there is no prescription other than the prescription of the frame rate up to 60P. Further, in a current state where HD devices have come into widespread use and have been developed and marketed, there is a strong opinion that it is difficult to add 120P thereto by revising the SMPTE 274 in the future. For this reason, a study was made on the method of transmitting the future high-frame signal, of which the frame rate is equal to the integer multiple of 50P-60P, by mapping the signal into the 1920×1080/50P-60P or 2048×1080/48P-60P of multi-channels prescribed in existing SMPTE 274 or SMPTE 2048-2. Furthermore, the current method of transmitting the 3840×2160 or 7680×4320/50P-60P through 10G-SDIs of multi-channels is being standardized as the SMPTE 2036-3. In addition, the method of transmitting the 4096×2160/48P-60P through 10G-SDIs of multi-channels can be proposed to be standardized as the SMPTE 2048-3.

(3) By thinning out a 4 k or 8 k signal for each p lines in the vertical direction, the video of the entire screen can be observed by using an existing monitor for HD or a waveform monitor, or an 8 k signal can be observed by using a future 4 k monitor or the like. Therefore, the present disclosure is effective for analysis of a fault for example when a video apparatus is developed.

(4) When 3840×2160/100P-120P signals or 7680×4320/100P-120P signals are transmitted at 10.692 Gbps in the mode D of four channels or 16 channels, the transmission system can be constructed with a minimum delay. Further, it is possible to cause the mapping method in which the frame of the class image of 3840×2160, 7680×4320 is thinned out for each p lines to match with the S2036-3, which is under consideration by the SMPTE. Note that, the S2036-3 relates to a mapping standard of 3840×2160/23.98P-60P or 7680×4320/23.98P-60P in the mode D of 10.692 Gbps in multi-channels.

(5) Further, by decreasing the number of pixels which are extracted at the time of thinning out or multiplexing pixels, it is possible to reduce the memory capacity used as a tentative storage region. Here, as the line thinning-out method of thinning out a 1920×1080/50P-60P signal so as to thereby convert it into 1920×1080/50I-60I signals of two channels, a method adopted in the standard of the SMPTE 372 is used. In this standard, a method of mapping a 1920×1080/50P-60P signal to 1920×1080/50I-60I signals of two channels is prescribed. Therefore, the mapping method according to the embodiments can match with the mapping method prescribed by the standard of the SMPTE 372.

### Modified Examples

Note that, the series of processing in the above-described embodiments may be executed by hardware or software. When the series of processing are executed by software, the series of processing can be executed by a computer in which a program constituting the software is incorporated in dedicated hardware or a computer in which a program for executing various functions is installed. For example, the series of processing may be executed by installing a program constituting desired software in a general personal computer.

Further, a recording medium in which a program code of the software realizing the function of the above described embodiment has been recorded may be supplied to the system or device. Needless to say, the function can be realized when a computer (or a control device such as CPU) of the system or device reads and executes the program code stored in the recording medium.

As the recording medium for supplying the program code in this case, for example, a flexible disk, a hard disk, an optical disc, a magnetooptical disc, a CD-ROM, a CD-R, a magnetic tape, a non-volatile memory card and a ROM can be used.

Further, by executing the program code that the computer reads, the function of the above described embodiment is realized. In addition, on the basis of the instruction of the program code, the OS or the like operating in the computer performs a part or the entire actual process. By this process, the function of the above described embodiment may be realized.

Further, the present disclosure is not limited to the above-mentioned embodiments, and it is apparent that various applications and modifications may be made without departing from the technical scope of the present disclosure described in the claims appended hereto.

The present disclosure contains subject matter related to that disclosed in Japanese Priority Patent Application JP 2011-126674 filed in the Japan Patent Office on Jun. 6, 2011, the entire contents of which are hereby incorporated by reference.

What is claimed is:

1. A signal transmission apparatus comprising:
a horizontal rectangular area thinning-out control section that
calculates first to t-th horizontal rectangular areas obtained by dividing each of successive first and second class images, in which the number of pixels of one frame is greater than the number of pixels prescribed by an HD-SDI format and which are defined by a m×n/a-b/r:g:b/10-bit, 12-bit signal, into t pieces in units of p lines in a vertical direction, when mapping pixel samples of the successive first and second class images into video data areas of first to t-th sub images which are defined by a m′×n′/a′−b′/r′:g′:b′/10-bit, 12-bit signal,
maps the pixel samples, which are read out from the first class image, into each line of the video data areas of the first to t-th sub images in units of p×m/m′ lines, when repeating, in order from the first class image to the second class image, processing of alternately mapping pixel samples, which are read out by dividing a single line into m/m′ pieces for each horizontal direction of the first and second class images, up to a p×m/m′ line in a vertical direction of each line in the video data area of each of the first to t-th sub images for each of the first to t-th horizontal rectangular areas, and then
maps the pixel samples, which are read out from the second class image, into a vertically subsequent to the line, into which the pixel samples are mapped, in units of p×m/m′ lines,
where m×n represents m samples and n lines in which m and n are positive integers, a and b are frame rates of progressive signals, r, g, and b are signal ratios in a prescribed signal transmission method, t is an integer equal to or greater than 8, m′×n′ represents m′ samples and n′ lines in which m′ and n′ are positive integers, a′ and b′ are frame rates of progressive signals, r′, g′, and b′ are signal ratios in a prescribed signal transmission method, and p is an integer equal to or greater than 1;
a line thinning-out control section that thins out the pixel samples for every other line of each of the first to t-th sub images, into which the pixel samples are mapped, so as to thereby produce interlaced signals;
a word thinning-out control section that thins out the pixel samples, which are thinned out for every other line, for every word, and maps the pixel samples into video data areas of HD-SDIs prescribed in SMPTE 435-2; and
a readout control section that outputs the HD-SDIs.

2. The signal transmission apparatus according to claim 1,
wherein
when the first and second class images are class images of UHDTV1 with m×n of 3840×2160, a-b of 100P, 119.88P, or 120P, and r:g:b of 4:4:4, 4:2:2, or 4:2:0,
the horizontal rectangular area thinning-out control section maps the pixel samples into video data areas of the first to t-th sub images with m′×n′ of 1920×1080, a′−b′ of 50P, 59.94P, and 60P, and r′:g′:b′ of 4:4:4, 4:2:2, or 4:2:0, and
the word thinning-out control section multiplexes the pixel samples into video data areas of a 10.692 Gbps stream which is prescribed in SMPTE 435-2 and is determined by a mode D of four channels corresponding to each of the first to t-th sub images.

3. The signal transmission apparatus according to claim 2, further comprising
a two-pixel thinning-out control section that
when thinning out two pixel samples adjacent to each other on the same line for every line from class images of UHDTV2, which is defined by a 7680×4320/100P, 119.88P, 120P/4:4:4, 4:2:2, 4:2:0/10-bit, 12-bit signal and in which successive first and second lines are repeated, so as to thereby map the two pixel samples into the first to fourth class images of the UHDTV1,
maps every other third pixel sample, which is included in each of odd-numbered lines from the first line of the class images of the UHDTV2, into the same line in the first class image of the UHDTV1 for every line,
maps every other third pixel sample, which is included in each of the odd-numbered lines from the first line of the class images of the UHDTV2 and is different from the pixel samples mapped into the first class image of the UHDTV1, into the same line in the second class image of the UHDTV1,
maps every other third pixel sample, which is included in each of even-numbered lines from the second line of the class images of the UHDTV2, into the same line in the third class image of the UHDTV1 for every line, and
maps every other third pixel sample, which is included in each of the even-numbered lines from the second line of the class images of the UHDTV2 and is different from the pixel samples mapped into the third class image of the UHDTV1, into the same line in the fourth class image of the UHDTV1.

4. The signal transmission apparatus according to claim 1,
wherein
when first to N-th class images, in which N is an integer equal to or greater than 2, including the first and second class images are class images of UHDTV1 defined by m×n of 3840×2160, a-b of (50P, 59.94P, or 60P)×N, r:g:b of 4:4:4, 4:2:2, or 4:2:0, and the number of lines of the class images equal to 0, 1, . . . , 2N−2, or 2N−1,
the horizontal rectangular area thinning-out control section maps the pixel samples, which are thinned out for every n/4N line from the first to N-th class images, for every (m/m′)×(n/4N) lines of the video data areas of the first to t-th sub images with m′×n′ of 1920×1080, a′−b′ of 50P, 59.94P, and 60P, r′:g′:b′ of 4:4:4, 4:2:2, or 4:2:0, and t=4N, and
the word thinning-out control section multiplexes the pixel samples into video data areas of a 10.692 Gbps stream which is prescribed in SMPTE 435-2 and is determined by a mode D of four channels corresponding to each of the first to t-th sub images.

5. The signal transmission apparatus according to claim 4, further comprising
a two-pixel thinning-out control section that
when thinning out two pixel samples adjacent to each other on the same line for every line from class images of UHDTV2, which is defined by a 7680×4320/(50P, 59.94P, 60P)×N/4:4:4, 4:2:2, 4:2:0/10-bit, 12-bit signal and in which successive first and second lines are repeated, so as to thereby map the two pixel samples into the first to fourth class images of the UHDTV1,
maps every other third pixel sample, which is included in each of odd-numbered lines from the first line of the class images of the UHDTV2, into the same line in the first class image of the UHDTV1 for every line,
maps every other third pixel sample, which is included in each of the odd-numbered lines from the first line of the class images of the UHDTV2 and is different from the pixel samples mapped into the first class image of the UHDTV1, into the same line in the second class image of the UHDTV1,
maps every other third pixel sample, which is included in each of even-numbered lines from the second line of the class images of the UHDTV2, into the same line in the third class image of the UHDTV1 for every line, and
maps every other third pixel sample, which is included in each of the even-numbered lines from the second line of the class images of the UHDTV2 and is different from the pixel samples mapped into the third class image of the UHDTV1, into the same line in the fourth class image of the UHDTV1.

6. The signal transmission apparatus according to claim 1,
wherein
when the first and second class images are 4096×2160 class images with m×n of 4096×2160, a-b of (47.95P, 48P, 50P, 59.94P, or 60P)×N where N is an integer equal to or greater than 2, r:g:b of 4:4:4 or 4:2:2,
the horizontal rectangular area thinning-out control section maps the pixel samples into video data areas of the first to t-th sub images with m′×n′ of 2048×1080, a′−b′ of 47.95P, 48P, 50P, 59.94P, and 60P, and r′:g′:b′ of 4:4:4 and 4:2:2, and
the word thinning-out control section multiplexes the pixel samples into video data areas of a 10.692 Gbps stream which is prescribed in SMPTE 435-1 and is determined by a mode B of six channels corresponding to each of the first to t-th sub images.

7. A signal transmission method comprising:
calculating first to t-th horizontal rectangular areas obtained by dividing each of successive first and second class images, in which the number of pixels of one frame is greater than the number of pixels prescribed by an HD-SDI format and which are defined by a m×n/a-b/r:g:b/10-bit, 12-bit signal, into t pieces in units of p lines in a vertical direction, when mapping pixel samples of the successive first and second class images into video data areas of first to t-th sub images which are defined by a m′×n′/a′−b′/r′:g′:b′/10-bit, 12-bit signal,
mapping the pixel samples, which are read out from the first class image, into each line of the video data areas of the first to t-th sub images in units of p×m/m′ lines, when repeating, in order from the first class image to the second class image, processing of alternately mapping pixel samples, which are read out by dividing a single line into m/m′ pieces for each horizontal direction of the first and second class images, up to a p×m/m′ line in a vertical direction of each line in the video data area of each of the first to t-th sub images for each of the first to t-th horizontal rectangular areas, and then
mapping the pixel samples, which are read out from the second class image, into a vertically subsequent line, into which the pixel samples are mapped, in units of p×m/m′ lines,
where m×n represents m samples and n lines in which m and n are positive integers, a and b are frame rates of progressive signals, r, g, and b are signal ratios in a prescribed signal transmission method, t is an integer equal to or greater than 8, m′×n′ represents m′ samples and n′ lines in which m′ and n′ are positive integers, a′ and b′ are frame rates of progressive signals, r′, g′, and b′ are signal ratios in a prescribed signal transmission method, and p is an integer equal to or greater than 1;
thinning out the pixel samples for every other line of each of the first to t-th sub images, into which the pixel samples are mapped, so as to thereby produce interlaced signals;
thinning out the pixel samples, which are thinned out for every other line, for every word, and maps the pixel samples into video data areas of HD-SDIs prescribed in SMPTE 435-2; and
outputting the HD-SDIs.

8. A signal reception apparatus comprising:
a write control section that stores HD-SDIs in a storage section;
a word multiplexing control section that performs word multiplexing on the pixel samples, which are extracted from the video data areas of the HD-SDIs read out from the storage section, for every line;
a line multiplexing control section that multiplexes the pixel samples, on which the word multiplexing is performed, into first to t-th sub images, which are defined by a m′×n′/a′−b′/r′:g′:b′/10-bit, 12-bit signal, for every line so as to thereby produce progressive signals, where m′×n′ represents m′ samples and n′ lines in which m′ and n′ are positive integers, a′ and b′ are frame rates of progressive signals, r′, g′, and b′ are signal ratios in a prescribed signal transmission method, and t is an integer equal to or greater than 8; and
a horizontal rectangular area multiplexing control section that
calculates first to t-th horizontal rectangular areas obtained by dividing each of successive first and second class images, in which the number of pixels of one frame is greater than the number of pixels prescribed by an HD-SDI format and which are defined by a m×n/a-b/r:g:b/10-bit, 12-bit signal, into t pieces in units of p lines in a vertical direction, when multiplexing pixel samples, which are read out from video data areas of first to t-th sub images, into the successive first and second class images,
multiplexes the pixel samples, which are read out from each line of the video data areas of the first to t-th sub images in units of p×m/m′ lines, into the first class image, when repeating, in order from the first class image to the second class image, processing of alternately multiplexing pixel samples, which are read out up to a p×m/m′ line in a vertical direction in the video data areas of the first to t-th sub images, into respective lines, each of which is divided into m/m′ pieces, in the first to t-th horizontal rectangular areas up to a p line in the first class image, and then
multiplexes the pixel samples, which are read out in units of p×m/m′ lines from a line vertically subsequent to the line at which the pixel samples are read out from the video data areas of the first to t-th sub images, into the second class image,
where m×n represents m samples and n lines in which m and n are positive integers, a and b are frame rates of progressive signals, r, g, and b are signal ratios in a prescribed signal transmission method, and p is an integer equal to or greater than 1.

9. The signal reception apparatus according to claim 8,
wherein
when the first and second class images are class images of UHDTV1 with m×n of 3840×2160, a-b of 100P, 119.88P, or 120P, and r:g:b of 4:4:4, 4:2:2, or 4:2:0,
the word multiplexing control section multiplexes, into lines, the pixel samples which are extracted from the video data areas of a 10.692 Gbps stream prescribed in SMPTE 435-2 and determined by a mode D of four channels corresponding to each of the first to t-th sub images, and
the horizontal rectangular area multiplexing control section maps, into the class image of the UHDTV1, the pixel samples which are extracted from video data areas of the first to t-th sub images with m′×n′ of 1920×1080, a′−b′ of 50P, 59.94P, and 60P, and r′:g′:b′ of 4:4:4, 4:2:2, or 4:2:0.

10. The signal reception apparatus according to claim 9, further comprising
a two-pixel multiplexing control section that
when multiplexing the pixel samples, which are extracted from the first to fourth class images of the UHDTV1, to positions of two pixel samples adjacent to each other on the same line for every line of class images of UHDTV2, which is defined by a 7680×4320/100P, 119.88P, 120P/4:4:4, 4:2:2, 4:2:0/10-bit, 12-bit signal and in which successive first and second lines are repeated,
multiplexes every other third pixel sample, which is extracted for each two pixel samples for every line from the same line in the first class image of the UHDTV1, on the same line which is each of odd-numbered lines from the first line of the class images of the UHDTV2,
multiplexes every other third pixel sample, which is extracted for each two pixel samples for every line from the same line in the second class image of the UHDTV1, on the same line, which is each of the odd-numbered lines from the first line of the class images of the UHDTV2, at a position different from that of each pixel sample which is multiplexed from the first class image of the UHDTV1,
multiplexes every other third pixel sample, which is extracted for each two pixel samples for every line from the same line in the third class image of the UHDTV1, on the same line which is each of even-numbered lines from the second line of the class images of the UHDTV2, and
multiplexes every other third pixel sample, which is extracted for each two pixel samples for every line from the same line in the fourth class image of the UHDTV1, on the same line, which is each of the even-numbered lines from the second line of the class images of the UHDTV2, at a position different from that of each pixel sample which is multiplexed from the third class image of the UHDTV1.

11. The signal reception apparatus according to claim 8,
wherein
when first to N-th class images, in which N is an integer equal to or greater than 2, including the first and second class images are class images of UHDTV1 defined by m×n of 3840×2160, a-b of (50P, 59.94P, or 60P)×N, r:g:b of 4:4:4, 4:2:2, or 4:2:0, and the number of lines of the class images equal to 0, 1, . . . , 2N−2, or 2N−1,
the word multiplexing control section performs the word multiplexing on the pixel samples which are extracted from the video data areas of a 10.692 Gbps stream prescribed in SMPTE 435-2 and determined by a mode D of four channels corresponding to each of the first to t-th sub images, and
the horizontal rectangular area multiplexing control section multiplexes, into the first to N-th class images for every n/4N line, the pixel samples which are read out for every (m/m′)×(n/4N) line from the video data areas of the first to t-th sub images with m′×n′ of 1920×1080, a′−b′ of 50P, 59.94P, and 60P, r′:g′:b′ of 4:4:4, 4:2:2, or 4:2:0, and t=4N.

12. The signal reception apparatus according to claim 11, further comprising
a two-pixel multiplexing control section that
when multiplexing the pixel samples, which are extracted from the first to N-th class images of the UHDTV1, to positions of two pixel samples adjacent to each other on the same line for every line of class images of UHDTV2, which is defined by a 7680×4320/(50P, 59.94P, 60P)×N/4:4:4, 4:2:2, 4:2:0/10-bit, 12-bit signal and in which successive first and second lines are repeated,
multiplexes every other third pixel sample, which is extracted for each two pixel samples for every line from the same line in the first class image of the UHDTV1, on the same line which is each of odd-numbered lines from the first line of the class images of the UHDTV2,
multiplexes every other third pixel sample, which is extracted for each two pixel samples for every line from the same line in the second class image of the UHDTV1, on the same line, which is each of the odd-numbered lines from the first line of the class images of the UHDTV2, at a position different from that of each pixel sample which is multiplexed from the first class image of the UHDTV1,
multiplexes every other third pixel sample, which is extracted for each two pixel samples for every line from the same line in the third class image of the UHDTV1, on the same line which is each of even-numbered lines from the second line of the class images of the UHDTV2, and
multiplexes every other third pixel sample, which is extracted for each two pixel samples for every line from the same line in the fourth class image of the UHDTV1, on the same line, which is each of the even-numbered lines from the second line of the class images of the UHDTV2, at a position different from that of each pixel sample which is multiplexed from the third class image of the UHDTV1.

13. The signal reception apparatus according to claim 8,
wherein
when the first and second class images are 4096×2160 class images with m×n of 4096×2160, a-b of (47.95P, 48P, 50P, 59.94P, or 60P)×N where N is an integer equal to or greater than 2, r:g:b of 4:4:4 or 4:2:2,
the word multiplexing control section multiplexes, into lines, the pixel samples which are extracted from the video data areas of a 10.692 Gbps stream prescribed in SMPTE 435-2 and determined by a mode B of six channels corresponding to each of the first to t-th sub images, and
the horizontal rectangular area multiplexing control section maps, into the class image of 4096×2160, the pixel samples which are extracted from video data areas of the first to t-th sub images with m′×n′ of 2048×1080, a′−b′ of 47.95P, 48P, 50P, 59.94P, and 60P, and r′:g′:b′ of 4:4:4 and 4:2:2.

14. A signal reception method comprising:
storing HD-SDIs in a storage section;
multiplexing the pixel samples, which are extracted from the video data areas of the HD-SDIs read out from the storage section, for every word;
multiplexing the pixel samples, on which the multiplexing is performed for every word, into first to t-th sub images, which are defined by a m′×n′/a′−b′/r′:g′:b′/10-bit, 12-bit signal, for every line so as to thereby produce progressive signals, where m′×n′ represents m′ samples and n′ lines in which m′ and n′ are positive integers, a′ and b′ are frame rates of progressive signals, r′, g′, and b′ are signal ratios in a prescribed signal transmission method, and t is an integer equal to or greater than 8; and
calculating first to t-th horizontal rectangular areas obtained by dividing each of successive first and second class images, in which the number of pixels of one frame is greater than the number of pixels prescribed by an HD-SDI format and which are defined by a m×n/a-b/r:g:b/10-bit, 12-bit signal, into t pieces in units of p lines in a vertical direction, when multiplexing pixel samples, which are read out from video data areas of first to t-th sub images, into the successive first and second class images,
multiplexing the pixel samples, which are read out from each line of the video data areas of the first to t-th sub images in units of p×m/m′ lines, into the first class image, when repeating, in order from the first class image to the second class image, processing of alternately multiplexing pixel samples, which are read out up to a p×m/m′ line in a vertical direction in the video data areas of the first to t-th sub images, into respective lines, each of which is divided into m/m′ pieces, in the first to t-th horizontal rectangular areas up to a p line in the first class image, and then
multiplexing the pixel samples, which are read out in units of p×m/m′ lines from a line vertically subsequent to the line at which the pixel samples are read out from the video data areas of the first to t-th sub images, into the second class image,
where m×n represents m samples and n lines in which m and n are positive integers, a and b are frame rates of progressive signals, r, g, and b are signal ratios in a prescribed signal transmission method, and p is an integer equal to or greater than 1.

15. A signal transmission system comprising:
a signal transmission apparatus that includes
a horizontal rectangular area thinning-out control section
calculating first to t-th horizontal rectangular areas obtained by dividing each of successive first and second class images, in which the number of pixels of one frame is greater than the number of pixels prescribed by an HD-SDI format and which are defined by a m×n/a-b/r:g:b/10-bit, 12-bit signal, into t pieces in units of p lines in a vertical direction, when mapping pixel samples of the successive first and second class images into video data areas of first to t-th sub images which are defined by a m′×n′/a′−b′/r¹:g′:b′/10-bit, 12-bit signal,
mapping the pixel samples, which are read out from the first class image, into each line of the video data areas of the first to t-th sub images in units of p×m/m′ lines, when repeating, in order from the first class image to the second class image, processing of alternately mapping pixel samples, which are read out by dividing a single line into m/m′ pieces for each horizontal direction of the first and second class images, up to a p×m/m′ line in a vertical direction of each line in the video data area of each of the first to t-th sub images for each of the first to t-th horizontal rectangular areas, and then
mapping the pixel samples, which are read out from the second class image, into a line vertically subsequent to the line, into which the pixel samples are mapped, in units of p×m/m′ lines,
where m×n represents m samples and n lines in which m and n are positive integers, a and b are frame rates of progressive signals, r, g, and b are signal ratios in a prescribed signal transmission method, t is an integer equal to or greater than 8, m′×n′ represents m′ samples and n′ lines in which m′ and n′ are positive integers, a′ and b′ are frame rates of progressive signals, r′, g′, and b′ are signal ratios in a prescribed signal transmission method, and p is an integer equal to or greater than 1,
a line thinning-out control section thinning out the pixel samples for every other line of each of the first to t-th sub images, into which the pixel samples are mapped, so as to thereby produce interlaced signals;
a word thinning-out control section thinning out the pixel samples, which are thinned out for every other line, for every word, and maps the pixel samples into video data areas of HD-SDIs prescribed in SMPTE 435-2, and
a readout control section outputting the HD-SDIs; and
a signal reception apparatus that includes
a write control section storing the HD-SDIs in a storage section,
a word multiplexing control section multiplexing the pixel samples, which are extracted from the video data areas of the HD-SDIs read out from the storage section, for every word,
a line multiplexing control section multiplexing the pixel samples, on which the multiplexing is performed for every word, into the first to t-th sub images for every line so as to thereby produce progressive signals, and
a horizontal rectangular area multiplexing control section
calculating the first to t-th horizontal rectangular areas obtained by dividing each of the successive first and second class images into t pieces in units of the p lines in the vertical direction, when multiplexing the pixel samples into the successive first and second class images,
multiplexing the pixel samples, which are read out from each line of the video data areas of the first to t-th sub images in units of the p×m/m′ lines, into the first class image, when repeating, in order from the first class image to the second class image, processing of alternately multiplexing pixel samples, which are read out up to the p×m/m′ line in the vertical direction in the video data areas of the first to t-th sub images, into respective lines, each of which is divided into m/m′ pieces, in the first to t-th horizontal rectangular areas up to the p line in the first class image, and then
multiplexing the pixel samples, which are read out in units of p×m/m′ lines from a line vertically subsequent to the line at which the pixel samples are read out from the video data areas of the first to t-th sub images, into the second class image.
